(19) United States
(12) Patent Application Publication
(10) Pub. No.: US 2026/0166826 A1
(43) Pub. Date: Jun. 18, 2026

(54) METHODS AND APPARATUS FOR MANUFACTURING AND SHIPPING AN OPTICAL LENS ADHERED TO A RECEIVING SURFACE

(71) Applicant: Atheneum Optical Sciences, LLC, Orange Park, FL (US)

(72) Inventors: W. Anthony Martin, Orange Park, FL (US); Randall Pugh, Jacksonville, FL (US); Ganesh Narayanan Kumar, Ponte Vedra Beach, FL (US); Christopher Wildsmith, Jacksonville, FL (US)

(21) Appl. No.: 19/416,726

(22) Filed: Dec. 11, 2025

Related U.S. Application Data
(60) Provisional application No. 63/733,160, filed on Dec. 12, 2024.

(51) Int. Cl. B29D 11/00; B29C 64/124; B29C 64/379; B29L 11/00; B33Y 10/00; B33Y 80/00; B65B 25/00; G02B 1/04

(52) U.S. Cl. CPC B29D 11/00134; B29C 64/124; B29C 64/379; B29D 11/00192; B65B 25/008; G02B 1/043; B29L 2011/0041; B33Y 10/00; B33Y 80/00

(57) ABSTRACT

A method of producing an ophthalmic lens including depositing polymerizable mixture onto a receiving surface of a substrate that is positioned within a package, layering the polymerizable mixture in one or more passes of an additive print head over the substrate where the layers form a three-dimensional structure of the ophthalmic lens, and curing the deposited mixture by exposing it to an actinic radiation, thereby initiating polymerization and forming a solid form of the ophthalmic lens. The method further requires sealing the substrate and formed ophthalmic lens within the package in a dry, non-hydrated state, where the formed ophthalmic lens remains adhered to the receiving surface, and shipping the sealed package having the substrate and formed ophthalmic lens therein in the dry, non-hydrated state.

### CROSS-REFERENCE TO RELATED APPLICATIONS

The present application claims priority benefit of U.S. provisional patent application 63/733,160, having a filing date of Dec. 12, 2024, and entitled, “METHODS AND APPARATUS FOR MANUFACTURING AND SHIPPING AN OPTICAL LENS ADHERED TO A RECEIVING SURFACE”; the entirety of which is incorporated herein at least by virtue of this reference.

### FIELD OF THE INVENTION

The present invention relates to methods, systems, and apparatus for additive manufacturing of ophthalmic lenses and other optical devices. More specifically, the invention pertains to the integration of 3D printing technology for producing lenses directly on a substrate which may be shipped to a destination while remaining on the substrate. The lens may be hydrated and released from the receiving surface at the destination. The lens may also be sterilized either at a situs of manufacture or the destination.

### BACKGROUND OF THE INVENTION

Contact lenses are used globally by millions of people to correct various visual impairments such as myopia, hyperopia, astigmatism, and presbyopia. They are also popular for cosmetic purposes, such as changing the appearance of the eye with colored lenses. The technology used to manufacture contact lenses has advanced significantly over the years, moving from basic cutting methods to sophisticated molding and 3D printing techniques, providing greater precision, reduced waste, and improved comfort for the user.

One of the traditional methods of manufacturing contact lenses is cast molding. In this process, using an injection molded mold, a liquid monomer material, typically a hydrophilic monomer, is dispensed into a lens mold cavity that is shaped to form the desired lens. The lens mold cavity typically consists of two parts: a convex surface that shapes the inner part of the lens and a concave surface that forms the outer part of the lens. The mold components are assembled together with the dispensed monomer. Once inside the mold, the monomer undergoes polymerization, typically through exposure to UV light or heat, solidifying into a contact lens.

Cast molding offers a cost-effective way to produce contact lenses at scale, making it the dominant method for high-volume production. However, despite its scalability, it comes with several limitations. SKU management complexities dictate that lenses must be produced in standard sizes and curvatures, which may not be ideal for all users. Additionally, the cast molding process can create excess material waste as any monomer that overflows the mold cavity is discarded after each cycle. When it comes to specialized or custom-fit lenses, the complexities and investment in the molds and tooling do not allow for low volume lens production.

Curing the entirety of the liquid monomer within the mold cavity also comes with complications, as the lens tends to shrink within the mold cavity during polymerization. To reduce shrinkage, the monomer is polymerized in the presence of an inert diluent such as boric acid ester. The diluent does not participate in the chemical reaction, but rather occupies space in the polymer matrix when polymerization occurs, which reduces the amount of shrinkage within the molds. Reducing shrinkage reduces stress on the matrix and enables the matrix to better maintain its shape during curing. The diluent must subsequently be removed from the matrix, however, which is done by replacing it with water/saline. The diluent reduces shrinkage during curing and also reduces swelling during subsequent washing and hydration.

On today's manufacturing lines, replacing the diluent with water is typically performed in a series of complex washing stations where the two-part mold is opened and the lenses are processed in large groups and placed in a leaching tank, where the lenses expand in the presence of water and release from the mold. Following this leaching and hydration process, the manufacturing lines complete complex packaging, sterilization and cartoning processes to prepare the lenses for shipping. Since the lenses have been removed from the mold during washing and hydration, they must be packaged and shipped contained in an appropriate solution such as a buffered saline solution to ensure that the lenses do not dry out or otherwise shrink or become distorted prior to use by the customer. For a single high volume, cast molding manufacturing line, the leaching and hydration processes can consume over one million gallons of water per year to produce approximately 30 million lenses, and the process performed on each lens typically takes approximately 30-40.

Further, because the lenses must be shipped in solution they must be sterilized and then packaged using appropriate materials that ensure that the lenses will remain hydrated and sterilized during shipping. Typically, lenses are placed into reservoirs that are filled with saline solution and sealed with a laminated foil lid stock. The sterilization process itself typically takes approximately one hour.

Not only is the back end of the manufacturing lines that perform hydration, packaging, sterilization and cartoning extremely large and complex, there is a significant amount of associated waste and environmental impact in these processes. The water used in the leaching and hydration process must be highly processed to remove the chemicals typically used in public water treatment plants and any other contaminants before it enters the leaching stations.

Following use it is discarded into waste water treatment plants.

As noted above, once the lens is removed from the substrate, it must be transferred to a sterile package for storage and transport. This packaging typically consists of a sealed container filled with a sterile solution, which helps to keep the lens hydrated and free from contaminants. However, the transfer process from the substrate to the packaging introduces another risk of damage or contamination. During the transfer, the lens must be carefully handled to avoid tearing, folding, or contamination from foreign particles. Even the smallest imperfection or contamination can compromise the lens's performance or safety.

Additionally, there is a risk that the lens may begin to dry out during handling, especially after it is removed from the mold cavity but before it is placed in sterile packaging. Contact lenses, especially those made from hydrophilic materials, need to remain hydrated to maintain their softness and flexibility. If the lens dries out even slightly, it can become brittle and more prone to tearing. Once dried, rehydration may not restore the lens to its original state, leading to reduced comfort for the wearer.

The final step of transferring the lens into its sterile packaging can introduce further challenges. If the lens is not placed correctly into the packaging, it may fold or become misaligned within the package. A folded lens can become misshapen and may not unfold properly when the user attempts to wear it, leading to discomfort, improper fit, and less than optimal vision correction. Additionally, any misalignment in the package may prevent the lens from being properly hydrated by the sterile solution, leading to dry spots or uneven hydration.

Furthermore, during the process of placing the lens into its packaging solution, there is a risk of introducing air bubbles into the sealed container. These air bubbles can press against the surface of the lens, causing it to deform. Even small distortions can affect the optical clarity and comfort of the lens. Additionally, the presence of air bubbles can reduce the effectiveness of the sterile solution in keeping the lens properly hydrated during transport and storage.

In addition to the mechanical risks associated with removing and transferring the lens, there are other potential drawbacks. For example, if the saline solution used to remove the lens is not properly controlled, it can leave behind residues or distortions on the lens surface. This can affect the optical clarity of the lens or introduce discomfort for the wearer. Furthermore, any manual handling of the lens increases the risk of contamination, which can lead to infections or other complications for the user.

The primary and secondary packaging used for producing and shipping lenses today is also a substantial bioburden.

It would be desirable to reduce the complexity of current commercial production processes as well as the environmental impacts of such processes.

### SUMMARY OF THE INVENTION

Provided herein is a method of producing an ophthalmic lens including the steps depositing polymerizable mixture onto a receiving surface of a substrate positioned within a package, layering the polymerizable mixture in one or more passes of an additive print head over the substrate, where successive layers of the polymerizable mixture are deposited to form a three-dimensional structure of the ophthalmic lens, and curing the polymerizable mixture deposited on the substrate by exposing it to an actinic radiation, thereby initiating polymerization and forming a solid form of the ophthalmic lens. The method further includes sealing the substrate and ophthalmic lens formed thereon within said package in a dry, non-hydrated state, where the formed ophthalmic lens remains adhered to the receiving surface, and shipping the sealed package having the substrate and formed ophthalmic lens therein in the dry, non-hydrated state.

The method may further include the step of, at a site remote to a site of forming the ophthalmic lens, at least partially filling the package with a hydration fluid to thereby hydrate the ophthalmic lens and release it from the receiving surface.

In yet another embodiment, the filling step may further include creating an opening in the sealed package, and injecting the hydration fluid into the package via the opening. The hydration fluid may be a saline solution.

In alternate embodiments, the substrate may be integral with the package, or the substrate may be removably secured to the package prior to forming the ophthalmic lens.

The sealing step may further include heat-sealing a foil lid onto the package to create a moisture barrier, and the foil lid may further include a pull tab such that the heat-sealed foil lid is subsequently peelable from the package using the pull tab.

In yet another embodiment, the method further includes the step of marking the package or the heat-sealed foil with a QR code, barcode, or other identification for tracking and traceability of the package during or after the forming of the ophthalmic lens.

In yet further alternate embodiments, the substrate may include a convex-shaped or a concave-shaped receiving surface, and the package may also further include a plurality of compartments that each contain a separate substrate.

Also provided herein is an ophthalmic lens package assembly including a substrate having a convex upper surface, a contact lens having a concave posterior surface and a convex anterior surface, where the concave anterior surface is adhered to the convex surface of the substrate, and where the contact lens is in a dry, non-hydrated state. The package has an upper side and a size and shape defining a recess therein, and the substrate and adhered contact lens is positioned within the recess. The assembly also includes a lid that is sealed to the upper size of the package that provides a moisture barrier to maintain the contact lens in the dry, non-hydrated state during shipping and handling.

In another embodiment, the substrate may be integral with the package.

Alternatively, the package may further include a substrate receiving portion, and the substrate is removably inserted into said substrate receiving portion. In this embodiment, the package may further include a flap-in mechanism and the substrate further includes a base locking mechanism, where the flap-in mechanism securely engages the base locking mechanism to provide secure positioning of the substrate and adhered contact lens within the package.

The flap-in mechanism may be a snap-in mechanism configured to securely snap the substrate into place within the substrate receiving portion.

In yet another alternative embodiment, the package further includes one or more compartments within the package, where each compartment is designed to securely hold at least one substrate, and the at least one substrate is either fixedly or removably attached to the package within the substrate receiving portion.

The lid may be a sealed foil that includes a pull-tab, allowing for easy opening of the package by a user or medical professional.

In yet another embodiment, the package is made from a biodegradable material or recyclable polymer, reducing environmental impact after use.

The package and substrate may be made of the same material, or alternatively be made of different materials.

Also provided herein is a method of providing an ophthalmic lens. The method includes forming the ophthalmic lens by positioning a package having a substrate within a cavity of the package at an additive manufacturing station having an additive manufacturing printhead, depositing droplets of a polymerizable mixture from the additive manufacturing printhead onto a receiving surface of the substrate, allowing the droplets of polymerizable mixture deposited onto the receiving surface to be acted upon by natural forces, integrating the droplets of polymerizable mixture deposited with gelled polymerizable mixture on the receiving surface to form a combined volume of polymerizable mixture, pinning the combined volume of polymerizable mixture to form a three-dimensional structure on the substrate within the package, and curing the combined volume of polymerizable mixture to form an un-hydrated ophthalmic lens attached to the substrate. The method further includes sealing the package with the substrate and formed lens therein with a moisture barrier to maintain the lens in a dry, un-hydrated state within the package, and shipping the sealed package to a third party with the ophthalmic lens in the dry, un-hydrated state and adhered to the substrate.

The method may further includes the step of instructing a user to insert hydration fluid into the package at the user location, where the hydration fluid hydrates the lens and releases it from said substrate.

The step of hydrating the ophthalmic lens may swell the ophthalmic lens to thereby facilitate its release from the substrate. In one embodiment, the hydration fluid is a saline solution.

According to yet another embodiment, the package includes one or more compartments designed to securely hold multiple substrates.

In yet another embodiment, the substrate is fixedly attached to the package during the additive manufacturing process, and may further be removably attached using a flap-in or snap-in mechanism.

In yet another embodiment, the package is part of a package array, allowing for multiple lenses to be printed simultaneously and separated post-production.

Also provided herein is a method of producing an ophthalmic lens including the steps of depositing polymerizable mixture onto a receiving surface of a substrate, layering the polymerizable mixture in one or more passes of an additive print head over the substrate, where successive layers of the polymerizable mixture are deposited to form a three-dimensional structure of the ophthalmic lens, and curing the polymerizable mixture deposited on the substrate by exposing it to an actinic radiation, thereby initiating polymerization and forming a solid form of the ophthalmic lens. The method further includes the step of inserting the substrate and attached ophthalmic lens into a package through a substrate receiving portion at a lower side of said package. The package further forms a recess, and the substrate and attached ophthalmic lens are positioned within the recess. The method also includes the steps of sealing the substrate and ophthalmic lens formed thereon within the package in a dry, non-hydrated state, wherein the formed ophthalmic lens remains adhered to the receiving surface, and shipping the sealed package having the substrate and formed ophthalmic lens therein in the dry, non-hydrated state.

### BRIEF DESCRIPTION OF THE DRAWINGS

FIG. 1 illustrates an exemplary prior art additive manufacturing system that can be used as part of the present invention.

FIGS. 2A-B illustrate an exemplary package for holding a receiving substrate of different sizes during or after additive manufacturing of a contact lens.

FIGS. 3A-B illustrate an integrated assembly comprising a package and a receiving substrate as a single unit according to some embodiments of the present invention.

FIG. 4 is a schematic illustration of a 3D printing apparatus for printing a contact lens on a substrate which may then be inserted into a package along with the printed lens.

FIG. 5 is a schematic illustration of an alternative 3D printing apparatus for printing a contact lens directly on a substrate within a package.

FIGS. 6A-B illustrate an exemplary integrated package comprising one substrate inside the package, and methods for sealing the package according to some embodiments of the present invention.

FIG. 7 illustrates an exemplary integrated package comprising two substrates inside the package.

FIG. 8 illustrates an exemplary package comprising two substrates inside their respective compartments within the same package.

FIG. 9 illustrates an exemplary package comprising concave shaped substrates instead of convex or convex shaped substrates in some embodiments of the present invention.

FIG. 10 illustrates an exemplary package array comprising a plurality of packages organized in a grid-like structure in some embodiments of the present invention.

FIG. 11 describes method steps that may be executed while practicing some implementations of the present invention.

FIG. 12 illustrates a flowchart of additional method steps that may be executed in some implementations of the present invention.

FIGS. 13 and 14 illustrate a dry lens and package for dry shipping of an optical lens according to the present invention.

FIGS. 15 and 16 illustrate an exemplary embodiment of a hydration device for use at a customer location.

### DETAILED DESCRIPTION

In recent years, 3D and inkjet printing technology has emerged as a potential alternative to traditional methods like injection molding. This method is described in detail in U.S. Pat. Nos. 11,370,162, 11,789,181, and 12,042,981 which are incorporated herein by reference in their entirety. 3D printing allows for the production of contact lenses with greater customization, higher precision, and less material waste. 3D printing utilizes a digital model to create the contact lens layer by layer, using a photopolymer that cures under ultraviolet (UV) light. The digital model can be tailored to match the specific curvature, optical power, and thickness required for each individual's eye, offering a level of customization that was not feasible with traditional methods.

Various terms may be used herein for which the following definitions apply:

“Actinic Radiation” as used herein refers to emission of energy that is capable of initiating a chemical reaction in an associated polymerizable mixture. In some embodiments, actinic radiation includes radiation within the wavelength range of 280-450 nm.

“Additive Manufacturing” as used herein refers to a process during which units of material are added to a structure being formed via the aggregation of the units of material into a shape.

“Cure” as used herein refers to exposure of a polymerizable mixture to actinic radiation and/or thermal energy of sufficient intensity and duration to crosslink a majority of the polymerizable mixture so exposed.

“Gelling” or “Gelation” as used herein refers to a degree of polymerization sufficient to stop or substantially slow a movement of polymerizable mixture deposited on a receiving surface while allowing subsequent droplets to meld with previously deposited polymerizable mixture without distortion. Gelled polymerizable mixture moves to a higher viscosity state, but stops short of full cure. Gelling enhances the management of flow and form, and provides a high-quality surface.

“Ophthalmic Lens” as used herein refers to any ophthalmic device that resides in, on or in front of the eye. These devices can provide optical correction or can be cosmetic. For example, the term lens can refer to a contact lens, an intraocular lens, an overlay lens, an ocular or optical insert, a spectacle lens, or other similar device through which vision is modified or corrected, or through which eye physiology is cosmetically enhanced (e.g., iris color) without impeding or adjusting vision.

“Optical Element” or “Optical Device” as used herein includes, but is not limited to, ophthalmic devices or lenses, lenses used in industrial applications, lenses for endoscopes or other medical devices, inspection devices, fiber optic devices, camera lenses, telescope lenses etc. Embodiments of particular current interest are ophthalmic devices or lenses.

“Oxygen Equilibrium Concentration” as used herein refers to the mean oxygen concentration in a mixture (i.e., polymerizable mixture) obtained if the mixture hypothetically is allowed to equilibrate at 1.0 atmospheres (1013 millibar) with an atmosphere having an oxygen concentration of X %.

“Pinning” as used herein refers to the application of actinic or thermal conditions, such as exposure to actinic radiation to a polymerizable mixture in an amount sufficient to achieve gelling but not cause full cure.

“Polymerizable Mixture” as used herein refers to a liquid mixture of components (reactive and possibly non-reactive components) which upon exposure to an external energy (e.g., actinic radiation in a range of 280-450 nm) is capable of undergoing polymerization to form a polymer or polymer network. A polymerizable mixture may include a monomer or prepolymer material which can be cured and/or crosslinked to form an ophthalmic lens or modify an existing lens or blank lens. Various embodiments can include polymerizable mixtures with one or more additives such as: UV blockers, bonding agents, tints, photo initiators or catalysts, and other additives one might desire in a lens.

The process of manufacturing a contact lens using 3D printing begins with the creation of a digital model. The digital model may typically be based on the measurements of the user's cornea and visual needs, facilitating a perfect fit and optimal visual correction. The polymer material is then deposited layer by layer onto a substrate, often made of polyolefins or glass. The shape and curvature of the substrate determine a final structure of the lens. In many cases, the substrate is designed with a convex shape that mimics the natural curvature of the human cornea. This facilitates that the contact lens closely matches the natural curvature of the eye, providing a comfortable fit and optimal vision.

The convex-shaped substrate onto which the contact lens is printed is carefully engineered to replicate the precise geometry needed for the lens. It supports the gradual build-up of the lens's layers and facilitates that the final product has the correct optical power and curvature. The convex shape allows for the creation of both concave and convex surfaces on the lens, which are required so that the lens fits comfortably on the cornea while providing the desired refractive correction.

The system and method described herein integrates these 3D production techniques into a manufacturing process that substantially reduces back-end manufacturing complexity and waste that exists in current injection molding processes. According to one embodiment, lenses can be produced on a substrate and packaged and shipped in a dry state on the substrate. In another embodiment, the lens/substrate combination can be directly placed into solution in a package. Both cases eliminate the need to remove the lens from the substrate prior to packaging or shipping.

With traditional cast molding manufacturing, shipping lenses still attached to the substrate (whether in the wet or dry state) is not feasible. As described above, the diluents that are used to mitigate shrinkage during cure must be washed out along with any other contaminants. The washing process initiates demolding, and the lenses must then be sterilized and packaged in a saline solution to avoid further drying and cracking of the hydrated lens.

With the additive printing techniques described in the patents listed above, printing of each layer is performed in an oxygen-controlled atmosphere, where oxygen levels are very low-on the order of less than 5.0 volume-% and preferably less than 1.0 volume-%, and the pressure is preferably 1.0 atm (1013 mbar). Further, each printed layer is approximately 10 microns thick, which is then partially cured or “pinned”, with final cure being performed following printing of all desired layers, which in some embodiments is 2 to 20 layers. The number of layers printed is a function of the desired lens thickness and the amount of material deposited per location per layer. The presence of oxygen inhibits the polymer reaction, as oxygen will itself react to terminate polymer chains, do chain transfers or otherwise incorporate into the matrix, causing unwanted by products and contaminants. By maintaining a very low oxygen level, inhibition of the polymeric reaction is reduced, biasing the system toward more polymerization. Further, the cumulative curing of the very thin layers in combination with the final cure, and the absence of a barrier to the UV radiation (i.e., a mold half that UV radiation must travel through in cast molding processes) achieves a more controlled and repeatable polymerization process. Because of the way the reaction is managed in the additive printing techniques in the cited prior art, the presence of impurities, non-reacted materials or by products is very low following final cure. As such, the complex washing and hydrating processes used in commercial cast molding manufacturing are not needed. Not only does this substantially reduce complexity and cost as compared to cast molding techniques, but it provides an opportunity not previously present for packaging the lens while still on the substrate.

As noted in the cited patents, the previously disclosed additive manufacturing process involves the formation of an ophthalmic lens directly onto a substrate. Deposition of a plurality of droplets of polymerizable mixture in a predetermined pattern on the substrate can be achieved using an inkjet printhead. Such conventional printheads are capable of simultaneous deposition of a plurality of droplets of the polymerizable mixture in a two-dimensional pattern such that multiple layers form the final article, such as an ophthalmic device. The two-dimensional pattern typically represents a size (area) that is at least the size of the ophthalmic device to be formed. A suitable commercially available print head is the Samba™ printhead from Fujifilm, e.g. the Samba™ G3L Printhead which has 2048 nozzles per module and is capable of deposition of liquids in the order of 2.4 picoliter maximum drop size at a 1200 native dpi accuracy.

The pattern of each layer of droplets is determined in relation to the desired shape and thickness of the target optical device or ophthalmic lens. For example, data gathered from a predetermined design, or gathered from measuring a patient's eye for a custom lens, can be used to generate input to the printer. Based on the data, a 3D model of the target ophthalmic lens is produced, and processed by software to convert the model to a series of thin layers and produce a file containing instructions tailored to the specific printer. For an ophthalmic lens, and specifically a contact lens, each layer may cover the entire area defining the lens, or any part thereof, and may vary in thickness across the area, which translates to different drop sizes across the area.

The substrate on which the patterns are deposited can be made of any suitable material such as glass or polyolefins such as polypropylene, polystyrene etc. In the case of a contact lens, the substrate is preferably convex in shape such that shape of the convex surface corresponds to the desired posterior surface of the non-hydrated contact lens. The substrate may also be concave in shape such that shape of the concave surface corresponds to the desired anterior surface of a non-hydrated contact lens, or corresponds to a surface of another optical device or ophthalmic lens such as an intraocular lens.

The atmosphere in which the deposition printing takes place must be controlled as described above. One approach for controlling the atmosphere is to use nitrogen as the inert gas to displace atmospheric oxygen to achieve an oxygen concentration at the desired level.

One exemplary polymerizable mixture that is suitable for use in the system and method described herein is etafilcon A. Etafilcon A is a well-known material used for forming contact lenses that may include approximately: ˜93-95% HEMA (2-hydroxyethyl methacrylate) and up to 3% MAA (methacrylic acid) and up to 3% EGDMA (ethyleneglycol dimethacrylate) and up to 1% TMPTMA (trimethylolpropane trimethacrylate) and up to 2% photoinitiator CGI 1700

During deposition of each layer, or every predetermined number of layers, the deposited polymerizable mixture is exposed to UV radiation or thermal heat to at least partially polymerize the deposited polymerizable material. The degree of polymerization is limited to a degree of gelation to stop or substantially slow the movement of the polymerizable mixture while allowing the subsequent droplets and layers to meld and form the structure without distortion. This process is referred to as “pinning,” and the wavelength of light or thermal energy must be correctly matched to the polymerizable mixture's photochemical or thermal properties. When partially polymerized, the deposited droplets move to a higher viscosity state, but stop short of full cure. Following deposition of all layers the article is exposed again to UV radiation or thermal heat to fully polymerize (fully cure) the entire article.

Since the maximum thickness of each layer deposited is preferably approximately 10 microns thick or less and the oxygen content of the atmosphere within which deposition takes place is maintained at a very low level, under these conditions, partial polymerization of each layer in combination with final cure of the lens yields very high polymerization and very low level of impurities or unincorporated side reaction products.

The lack of traditional diluents and the minimal residuals and contaminants in the fully formed lens eliminates the need for the complex washing and hydration processes in current commercial cast molding lines. Using the additive manufacturing techniques, the formed lens does not necessarily have to be removed from the substrate on the manufacturing line.

The present invention leverages this unique aspect of additive manufacturing in a manner that substantially simplifies the downstream post processing and packaging processes. As will be described in greater detail below, the combined lens and substrate remain together as the lens is packaged and shipped to the customer. Various embodiments will be described further below, including embodiments where the combined lens and substrate are packaged and shipped in a “wet” environment, and those where the combined lens and substrate are packaged and shipped in a “dry” environment.

### “Wet” Packaging

Various embodiments in which the combined lens and substrate may be packaged and shipping in a “wet” environment will now be described in detail. In one embodiment, the combined lens and substrate may be placed into, or form part of a package that is filled with a sterilization or saline solution, which is carefully selected to maintain the biocompatibility and hydration of the ophthalmic lens. Once the sterilization solution is added, the package is sealed using a heat-sealed foil or a similar sealing mechanism, ensuring the environment within the package remains sterile and the lens stays hydrated. The heat-sealed foil can be peelable, and may include a pull tab for easy access, allowing users or medical professionals to remove the lens without compromising sterility. For added traceability and tracking, the package or the heat-sealed foil may be marked with a QR code or barcode, which helps monitor the package throughout the manufacturing and distribution process.

In another variation, the package itself is sterilized by autoclaving prior to the addition of the sterilization or saline solution, providing an additional layer of safety against contaminants before it reaches the market. This method facilitates the creation of high-quality ophthalmic lenses while streamlining the packaging process to provide lens safety and effectiveness.

In other embodiments, the package may be designed to securely receive and hold in place a substrate on which the lens is formed while positioned within the package.

The package may alternatively be designed to receive and hold more than one substrate on which lenses are formed while positioned within the package. In other embodiments, the substrate may be integrally formed with the package rather than inserted and held within the package.

These various embodiments will be described in more detail below.

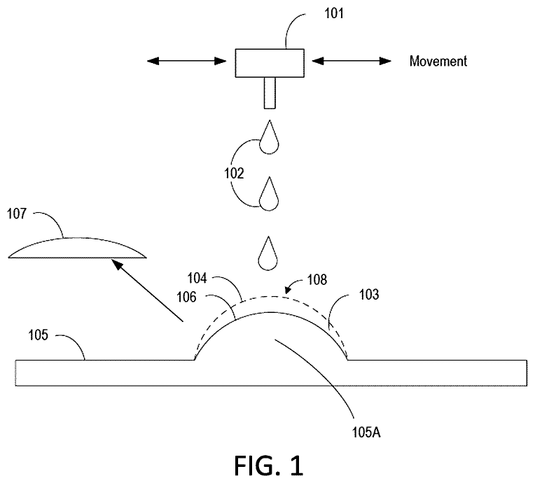

FIG. 1 illustrates an exemplary method of printing a contact lens onto a convex-shaped substrate 105A using a controlled deposition technique of the prior art. A printhead 101, depicted at the top of the diagram, is responsible for dispensing droplets of polymerizable mixture 102 onto a receiving surface 106 of the convex-shaped substrate 105A. The movement of the printhead 101 (or alternatively the movement of the substrate under the printhead), as indicated by the horizontal arrows, allows it to traverse across the substrate's surface during the deposition process, providing complete coverage. The printhead 101 is programmed to follow a predefined pattern, which corresponds to the optical and structural requirements of the final contact lens. This pattern governs the deposition of the polymerizable mixture 102 in specific locations, dictating the thickness and optical properties of the resulting lens. The process is highly controlled, with each droplet of polymerizable mixture 102 precisely metered to avoid excess or inadequate material build-up. The movement of the printhead 101 (or the substrate underneath) is synchronized with the deposition process, allowing for accurate layering of the polymerizable mixture 102 across the convex-shaped substrate 105A.

The convex-shaped substrate 105A forms the foundation upon which the contact lens will be built. Its curved surface mirrors the natural curvature of the cornea, and it provides a stable base for the deposition of the polymerizable mixture 102. As the droplets are deposited, they begin to accumulate on the receiving surface 106 of the convex-shaped substrate 105A, forming the volume of the deposited polymerizable material 103. The polymerizable mixture 102 adheres to the receiving area 106 of the substrate 105A, which is designed specifically to interact with the polymer. An apex 108 of the convex-shaped substrate 105A is the highest point where the initial droplets are deposited, guiding the material as it spreads out across the receiving surface 106. The shape of the substrate 105A is important in shaping the concave inner surface of the contact lens, which will eventually rest against the cornea of the wearer. As the polymerizable mixture 102 builds up, it begins to form the lens's desired optical structure, with varying thicknesses and curvatures depending on the specifications of the lens design.

The deposition process continues with multiple passes of the printhead 101. As the printhead 101 moves back and forth across the substrate 105 (or the substrate moves under the printhead), it deposits the polymerizable mixture 102 in successive layers, gradually building up the structure of the contact lens. The pattern used by the printhead 101 may be based on a two-dimensional map that dictates the amount of material to be deposited at each location. The two-dimensional map may be a thickness map derived from the optical requirements and geometry of the desired lens. The deposition process continues multiple times until a sufficient volume of material 103 has been deposited to cover the entire footprint of the lens design. As the material 103 builds up, the outer surface of the polymerizable mixture forms surface 104, shaping the exterior side of the lens.

As the polymerizable mixture 102 is deposited, it begins to form a cohesive mass on the receiving surface 106 of the convex-shaped substrate 105A. The material flows evenly across the receiving surface 106, with naturally occurring forces such as surface tension and intermolecular forces acting to smooth out the deposited material. These forces help to fill any minor surface irregularities that may arise during deposition, contributing to the optical clarity and overall quality of the final lens. The printhead 101 continues to make successive passes over the substrate 105, building up the lens layer by layer. The polymerizable mixture 102 gradually melds with the previously deposited layers, creating a uniform structure without visible striations or defects.

The precision of the printhead's movements relative to the substrate and vice-versa is important to the success of this process. The system controlling the printhead 101 uses advanced algorithms to calculate the ideal deposition pattern, so that the lens's optical properties are optimized. The deposited material 103 is constantly monitored to facilitate that it adheres properly to the receiving area 106 of the substrate 105 and that it forms the correct three-dimensional shape. Any deviations in the deposition process may result in a lens that does not meet the required specifications, making it unusable for its intended purpose.

Once the desired amount of polymerizable mixture 103 has been deposited, the next step is to cure the material. Curing can be achieved through various methods, including exposure to ultraviolet (UV) light, heat, or other forms of energy. The curing process initiates the polymerization of the material 103, transforming it from a liquid or gel-like state into a solid lens. During this process, the material 103 hardens and takes on its final mechanical and optical properties of the desired pre-hydrated lens. The curing step is important for locking in the lens's shape and facilitating that it remains stable during use. The convex-shaped substrate 105A plays a key role during this stage, as it maintains the curvature of the lens while the material solidifies.

Once the lens has been fully printed and cured, according to the present invention the convex-shaped substrate 105A with the lens still attached may be packaged and provided to a customer still in-tact. This eliminates the need for removal of the lens from the substrate and further handling of the lens itself to transfer it independently for packing, which reduces the risk of contamination and helps ensure that the lens remains in pristine condition until it is ready to be used by the wearer. The integrated design also simplifies the manufacturing process, as there is no need to transfer the lens between different substrates or handling stations.

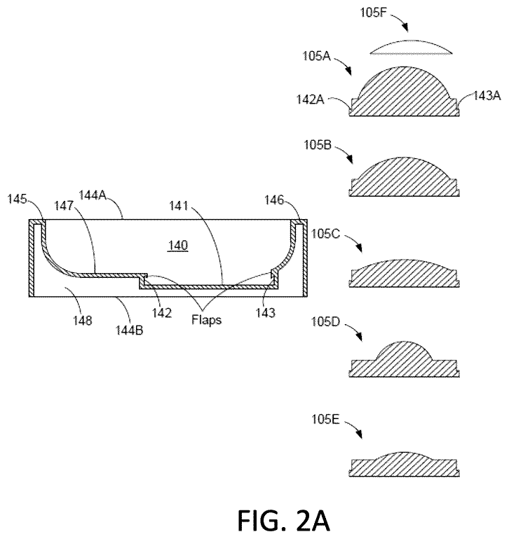

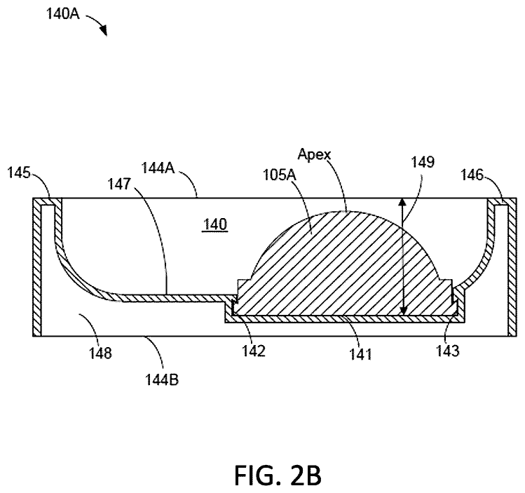

FIG. 2A illustrates one embodiment of a package 140 that can hold receiving substrates 105A-105E of various sizes during or after the additive manufacturing of a contact lens in accordance with the present invention. In some embodiments, the package 140 may serve as a support chamber where the lens is printed, cured, and possibly even stored. The package 140 typically has an open upper side and otherwise has a recess or cavity designed to accommodate receiving substrates (105A-105E) of different sizes and types, which are useful for shaping the contact lens during the printing process. Each substrate (105A-105E) may be tailored to meet specific optical needs, and the package 140 may allow for secure and stable retention of these substrates.

In some embodiments, one of the substrates (105A-105E) is first inserted into the package 140, and subsequently, the package 140, with the substrate securely placed inside, is introduced into the additive manufacturing process. During this process, the contact lens is directly printed onto the substrate while it remains housed within the package 140, so that the substrate stays firmly positioned throughout the lens production process. This process, as discussed in detail in FIG. 2B below, allows for seamless integration of the substrate and package 140, reducing the need for any intermediate handling steps and minimizing the risk of contamination or damage to the substrate and lens during the manufacturing process.

The package 140 includes a substrate receiving portion 141, which is the area where one of the receiving substrates 105A-105E can be inserted before or during the lens manufacturing process. The substrate receiving portion 141 is configured to fit various shapes and sizes of receiving substrates, so that they are held securely in place during the additive manufacturing process. The receiving portion 141 comprises a planar structure that conforms to the base of the convex-shaped substrates (105A-105E). Additionally, the substrate receiving portion 141 may comprise a flap-in mechanism 142-143 for locking the substrates (105A-105E) in place. The flap-in mechanism 142-143 is an innovative retention method that prevents movement of the substrates (105A-105E) during deposition or curing processes, and after sealing the package 140. In some embodiments, the flap-in mechanism 142-143 may be referred to as a snap-in mechanism.

The flap-in mechanism 142-143 may consist of flaps located on at least one side of the substrate receiving portion 141. In some embodiments, the flaps may be located on all sides of the substrate receiving portion 141, for example, comprising a circular shape. These flaps are designed to engage with a base locking mechanism 142A-143A present on the substrates, such as 105A. For example, the base of the receiving substrate 105A includes a base locking mechanism 142A-143A, which fits snugly into the flap-in mechanism 142-143. This creates a secure connection between the substrate 105A and the package 140, preventing the substrate 105A from shifting during manufacturing. The locking mechanism 142A-143A not only stabilizes the substrate 105A but also creates a seamless integration between the substrate 105A and the package 140.

Different embodiments of the flap-in mechanism 142-143 may exist, depending on the specific design of the contact lens manufacturing system. For example, in some embodiments, the flap-in mechanism 142-143 may be spring-loaded, allowing the flaps to automatically snap into place when the substrate 105A is inserted. This may be useful in high-speed manufacturing processes where quick and efficient locking mechanisms are necessary. Other embodiments may use a magnetic locking mechanism, where magnetic elements embedded in both the flaps (in the flap-in mechanism 142-143) and the base of the substrate 105A engage to hold the substrate 105A in place. This type of mechanism may be beneficial for environments where minimal mechanical contact is desired to avoid contamination.

The flap-in mechanism 142-143 can also be adapted to fit various base locking mechanisms 142A-143A depending on the substrate's shape and material. For example, substrates like 105A-105E may each have different base designs to accommodate specific lens types or sizes. In some embodiments, the base locking mechanism 142A-143A may include ridges or grooves that align with corresponding features on the flap-in mechanism 142-143. This may allow the package 140 to securely hold substrates (105A-105E) of different sizes and shapes without requiring significant modification to the overall package design. Additionally, the flap-in mechanism 142-143 may be adjustable, allowing it to accommodate substrates with varying heights or diameters.

As seen in FIG. 2A, the substrates 105A-105E may vary in both size and shape, demonstrating the flexibility of the package 140. The base locking mechanism 142A-143A of each substrate is designed to interact with the flap-in mechanism 142-143, regardless of the specific size or shape of the substrate. This versatility makes the package 140 an adaptable solution for a wide range of lens manufacturing applications.

The package 140 may also comprise additional design elements that support the overall functionality of the system. For example, the substrate receiving portion 141 may include cushioning elements or a soft lining that protects the base of the substrates (105A-105E) during insertion and removal. This feature may particularly be important in delicate manufacturing processes where any movement or damage to the substrate can affect the quality of the final lens. Additionally, the flap-in mechanism 142-143 may be equipped with sensors or mechanical indicators that provide feedback to an operator or user, confirming that the substrate is securely locked in place before the printing process begins.

In some embodiments, the package 140 can be customized for different types of lens manufacturing processes. For example, in a 3D printing-based manufacturing process, the package 140 may be designed with transparent materials that allow UV light or other curing energy sources to pass through the package 140 to facilitate curing on the substrate. Alternatively, in an injection molding process, the package 140 may include cooling elements or vents to facilitate the rapid solidification of the polymer material used to form the lens.

The package 140 may also be equipped with additional components that enhance the functionality of the flap-in mechanism 142-143 and substrate locking 142A-143A. For example, automated systems may be integrated into the flap-in mechanism 142-143, allowing it to engage and disengage the substrates (105A-105E) with minimal human intervention. This may particularly be useful in large-scale manufacturing environments where efficiency and precision are paramount. Additionally, the package 140 may include RFID or barcode scanning technology to track the substrates and lenses throughout the manufacturing process, providing real-time data on the status and location of each lens.

In some embodiments, the flap-in mechanism 142-143 may include a release button or lever that allows for quick and easy substrate removal if required for any reason.

The package 140 may also serve as a storage or transport container for the lenses after they have been manufactured. Once the substrate and lens have been removed from the manufacturing system, they can remain securely locked in the package 140 for transport to a sterilization station, for packaging, or even for delivering to an end user. The package 140 may be designed to accommodate various sterilization processes, such as autoclaving or chemical sterilization without requiring the lenses to be transferred to a different container. This reduces the risk of contamination and minimizes handling of the lenses, protecting their optical quality.

In another embodiment, the package 140 can include multiple compartments for holding several substrates at once. For example, a multi-compartment version of the package 140 may include separate flap-in mechanisms for each substrate, allowing the manufacturing system to produce multiple lenses in parallel. This may increase production capacity and reduce the overall time required to manufacture a batch of lenses. The package 140 may be equipped with automated systems to engage and disengage each substrate individually, allowing for efficient management of the manufacturing process.

The package 140 may also include external features that facilitate integration with larger manufacturing systems. For example, the package 140 may be equipped with alignment pins or rails that allow it to be easily loaded into a robotic assembly line. This may enable the package 140 to be transferred between different stages of the manufacturing process, such as 3D printing, curing, and packaging, without the need for manual handling. Additionally, the package 140 may include identification markers, such as QR codes or serial numbers, to help track individual lenses throughout the production process.

After the substrate 105A and the attached contact lens are positioned securely within the package 140, according to one embodiment the next step is sterilization. In some embodiments, the package 140 may be designed to accommodate various sterilization techniques. For example, the package 140 may be exposed to autoclaving or chemical sterilization methods so that the contact lens and the inner surfaces of the package are free from contaminants. The package 140 may be made of materials capable of withstanding high temperatures or chemical exposure, depending on the sterilization process used.

Alternatively, rather than sterilizing the package 140 through external means, the package 140 may be filled with a sterilizing solution. The solution may be a saline or isotonic solution, which is typically used to hydrate and preserve contact lenses. Once the substrate 105A and the lens are placed inside the package 140, the package can be filled with this solution to maintain the lens in an optimal state for transportation and storage. The saline solution may serve a dual purpose: keeping the lens hydrated and facilitating a sterile environment during the product's journey to a consumer.

Once the package 140 is filled with the solution or undergoes the sterilization process, it is sealed with a foil or similar sealing material. The foil may be heat-sealed onto the edges 145-146 of the package 140, creating an airtight and sterile environment within the package 140. The foil seal prevents contaminants, dust, and microorganisms from entering the package 140, thus preserving the sterility and quality of the contact lens. The heat-sealing process may be automated in large-scale manufacturing environments, providing consistency and speed during the final stage of packaging.

Once sealed, the package 140 with the substrate 105A and the contact lens inside is ready for transportation to market. The package 140 can be designed for ease of handling and distribution, with additional features such as barcodes or RFID tags to track the package through the supply chain. Since the contact lens remains attached to the substrate 105A throughout the entire process until the package is filled with solution, there is minimal risk of damage or contamination due to handling, reducing the chances of product defects and increasing the reliability of the final product.

Referring again to FIG. 2A, the package 140 comprises several important structural elements, including a top surface 144A, a bottom surface 144B, and a substrate holding body 147. The top surface 144A is an open or hollow portion through which a receiving substrate, such as 105A, is inserted into the package 140. The bottom surface 144B of the package 140 provides a flat base that supports the entire structure. The substrate holding body 147 is located above a cavity 148 and serves as the primary support for the inserted substrate. The holding body 147 securely grips the base of the substrate 105A or other receiving substrates 105B-105E to prevent movement during the manufacturing process or transport. The holding body 147 comprises the substrate receiving portion 141 designed with the flap-in mechanism 142-143 which conforms to the base locking mechanism 142A-143A of the substrates 105A-105E.

The cavity 148 beneath the substrate holding body 147 may serve multiple functions, including providing space for cushioning materials or safety mechanisms. In some embodiments, the cavity 148 may be filled with a material such as foam, sponge, or soft polymers to protect the substrate 105A and the printed lens during transportation or handling. These cushioning materials may absorb shocks and vibrations, facilitating that neither the substrate 105A nor the lens is damaged during transit. Additionally, the cavity 148 may contain antimicrobial or sterilizing agents to maintain the hygiene of the lens and substrate.

Referring now to FIG. 2B, an exemplary package 140A is illustrated with one of the substrates, for example, 105A, inserted into the package 140. This figure demonstrates the detailed interaction between the substrate 105A and the package 140A, highlighting the mechanics involved in securing the substrate 105A for subsequent processes, such as additive manufacturing or transport. The base locking mechanism 142A-143A of the substrate 105A snaps into place within the substrate receiving portion 141, engaging securely with the flap-in or snap-in mechanism 142-143. This provides a stable and fixed position for the substrate 105A within the package, so that it remains immobile during handling or any other process.

The snap-in mechanism 142-143 allows the substrate 105A to be easily inserted and locked into place without the need for manual adjustment, providing a reliable hold on the substrate 105A. Once the substrate 105A is locked into the receiving portion 141, the package 140A acts as a protective chamber, both during the contact lens printing process and during subsequent transportation. The alignment of the base locking mechanism 142A-143A with the flap-in mechanism 142-143 not only facilitates easy insertion but also helps to prevent any movement or misalignment of the substrate while the lens is being printed.

The height 149 of the top surface 144A, from the substrate receiving portion 141, is designed to be greater than the height of the apex of the convex-shaped substrate 105A. This configuration is useful in ensuring that when a protective foil is sealed over the package 140 at the edges 145-146, the apex of the substrate 105A does not collide with the foil. This is an important consideration because contact between the foil and the apex of the substrate may lead to damage to the lens or disrupt the integrity of the sealed package. By maintaining a clearance between the apex and the foil, the design prevents pressure on the printed lens, reducing the risk of deformation or contamination.

In some embodiments, the foil used to seal the package 140 may be a multi-layered laminate material, which may include layers of aluminum, plastic, or other barrier materials that protect the contact lens from external elements such as dust, moisture, and bacteria. The clearance provided by the height 149 allows for the foil to be securely sealed along the edges 145-146 without disturbing the contact lens housed on the substrate 105A, and within the package 140.

In some embodiments, the substrate 105A and the package 140 may be made from the same material or different materials, depending on the requirements of the contact lens manufacturing process, the durability needed for the package 140, and the specific use case for the lens. If the substrate 105A and package 140 are made from the same material, a common choice may be a biocompatible plastic or polymer, such as polypropylene (PP) or polyethylene (PE). These materials are well-suited for medical applications, including contact lens manufacturing, due to their high chemical resistance, low cost, and ease of molding or shaping into complex geometries. Polypropylene or polyethylene may allow for smooth integration between the substrate 105A and the package 140, as their physical properties provide consistency in thermal expansion, which can be important during manufacturing and transport. Additionally, using the same material for both the substrate and the package simplifies the recycling process, as the package 140 and substrate 105A can be disposed of or recycled together without the need for separation.

In some embodiments, the substrate 105A and the package 140 may be made from different materials to optimize their specific functions. For example, the substrate 105A, which directly supports the contact lens during printing and curing, may be made from a more rigid material such as polymethyl methacrylate (PMMA), glass, or a similar hard plastic. PMMA is known for its excellent optical clarity, rigidity, and biocompatibility, making it an ideal material for use as a substrate in the precise manufacture of contact lenses. The rigidity of PMMA may provide a stable foundation during the printing process, so that the contact lens maintains its exact shape and curvature.

On the other hand, the package 140 may be made from a more flexible material, such as silicone rubber or thermoplastic elastomers (TPE). These materials may allow the package 140 to absorb impacts and protect the lens during transport, while also providing a secure yet flexible housing for the substrate 105A. Silicone rubber, for example, is known for its flexibility, chemical resistance, and ability to withstand sterilization processes such as autoclaving, making it a durable choice for the package 140. TPE materials, on the other hand, offer a combination of flexibility and toughness, providing both protection and resilience during transportation.

Alternatively, the substrate 105A may be made from a transparent polymer such as polycarbonate (PC) or polystyrene (PS), both of which offer good optical clarity, impact resistance, and durability. These materials may support the precise deposition of the polymerizable mixture during the lens printing process, while still providing a robust surface that can withstand the curing and handling stages. Polycarbonate is particularly known for its toughness and transparency, making it a preferred choice for applications where impact resistance is important, such as in the handling and transport of delicate medical products like contact lenses.

For the package 140, a more rigid material like ABS (Acrylonitrile Butadiene Styrene) may be used to provide structural support and durability. ABS is a strong, impact-resistant thermoplastic that can be easily molded into complex shapes and is widely used in packaging solutions for delicate products. By using a more rigid material for the package 140, the overall structure may protect the lens and substrate from external forces, such as drops or impacts, while still being lightweight and easy to handle. Additionally, ABS can be heat-sealed or combined with a foil laminate for sealing the package, providing an airtight and sterile environment for the contact lens.

In some embodiments, the substrate 105A and the package 140 may be coated with materials that enhance their properties. For example, the substrate 105A may be coated with an anti-adhesion layer, such as PTFE (polytetrafluoroethylene), to prevent the polymerizable material from sticking to the substrate during the printing process. This may facilitate easier removal of the contact lens if needed, while still allowing the substrate 105A to maintain its structural integrity. The package 140 may be coated with an antimicrobial layer to prevent the growth of bacteria or fungi during storage and transport, so that the lens remains sterile until it reaches the end user.

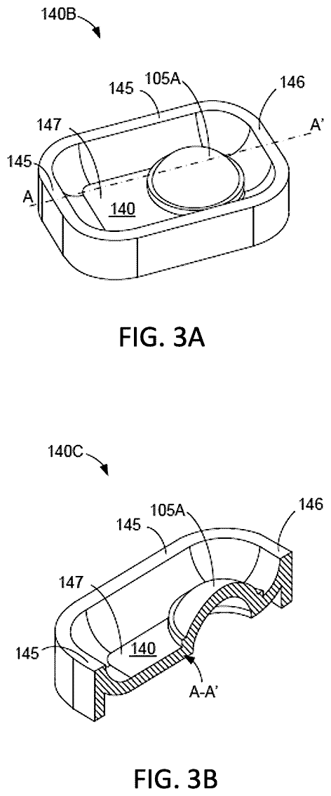

In another embodiment, the convex substrate 105A may be molded directly into the body of the package 140, meaning that the substrate 105A itself is an inherent part of the package 140. Referring now to FIGS. 3A-3B, an integrated assembly 140B is illustrated, comprising a package 140 and a receiving substrate 105A as a single inseparable unit, according to some embodiments of the present invention. This integrated design simplifies the manufacturing, packaging, and handling process by combining the substrate 105A and the package 140 into a single continuous unit 140B made of the same material. The use of a single material for both the package 140 and the receiving substrate 105A eliminates the need for separate assembly steps or interlocking mechanisms, which may potentially introduce risks of contamination, misalignment, or instability during production and transport. An optical lens, such as for example a contact lens, may be formed on the receiving substrate via deposition of one or more patterns of droplets of polymerizable mixture, as described herein.

The material for the integrated assembly 140B may be a biocompatible polymer, such as polypropylene or polyethylene, which offers the strength, flexibility, and chemical resistance necessary for both the substrate 105A and the package 140. These materials provide a seamless transition between the substrate 105A and the surrounding package 140, providing a uniform structure that can withstand the various stages of the contact lens manufacturing process, including deposition, curing, sterilization, and transport. In some embodiments, the integrated assembly 140B may comprise the substrate 105A made of one material and the package 140 made of another material different from the substrate 105A.

The substrate holding body 147 is an integral part of the package 140, serving as the primary support structure for the receiving substrate 105A. The substrate holding body 147 is designed to maintain the substrate 105A in a stable and secure position within the package 140. This prevents movement during manufacturing processes, such as 3D printing or curing of the contact lens. Additionally, the substrate holding body 147 may be contoured to match the shape of the substrate 105A, further stabilizing it within the package 140 and preventing any unwanted shifting or displacement.

The top edges 145-146 of the package 140 are designed to facilitate sealing the package 140 after the contact lens is manufactured on the substrate 105A. These edges may be flat or slightly raised to accommodate a foil or other sealing material, which can be heat-sealed to create an airtight and sterile environment within the package 140. The sealed package may protect the lens from contaminants such as dust, bacteria, and moisture, so that it remains in pristine condition until it reaches the end user.

In FIG. 3B, the cross-sectional view 140C of the integrated assembly 140B is depicted along the line A-A′, providing a detailed look at the internal structure of the package 140 and the substrate 105A. This view highlights how the substrate holding body 147 seamlessly transitions into the receiving substrate 105A, demonstrating the inseparability of the two components. The cross-sectional view also provides a clearer perspective of how the top edges 145-146 align with the substrate 105A, offering insight into the overall construction of the assembly 140C.

The design 140B also allows for easy handling during manufacturing. Since the substrate 105A is inseparably integrated into the package 140, there is no need for additional handling of the substrate 105A itself, reducing the chances of contamination or damage during production. Once the contact lens is printed onto the receiving substrate 105A, the entire package 140 can be transferred directly to the next stage of the process, such as curing, sterilization, or sealing, without the need to remove or reposition the lens.

In some embodiments, the top edges 145-146 of the package 140 may feature additional sealing mechanisms, such as a tamper-evident seal or a pull-tab for easy opening. Such a design may further enhance the usability and safety of the package 140, so that the lens remains sterile until it is ready to be used. The tamper-evident seal may be made from a transparent material, allowing for visual inspection of the lens without opening the package.

Furthermore, the integrated nature of the package 140 and the receiving substrate 105A simplifies the manufacturing process by eliminating the need for separate components. This reduces the complexity of production, lowers manufacturing costs, and improves overall product consistency. By using a single material and construction process, manufacturers can streamline their operations, resulting in higher efficiency and fewer errors.

The receiving substrate 105A may also be engineered with specific surface properties to enhance the adhesion of the polymerizable material used in contact lens printing. For example, the surface may be treated with a plasma coating, or microtextured to increase the surface area and improve the bonding of the lens material to the substrate 105A. This may enhance the overall quality of the contact lens, so that it adheres properly to the substrate 105A during the printing and curing processes.

The package 140 may also include additional features to facilitate handling during transport. For example, the exterior of the package 140 may be textured or include gripping surfaces to make it easier for workers to handle, especially in sterile environments where gloves are used. Additionally, the package 140 may be designed with stacking features, allowing multiple packages to be easily stored and transported without risk of damage.

The package 140 as illustrated in FIG. 3A is designed with a rectangular shape, featuring smooth or curved corners along its top edges 145-146. The rectangular form offers practicality in terms of handling, stacking, and storage, making it suitable for various stages of the contact lens manufacturing and transport processes. The rounded or curved corners enhance ergonomics, reducing the risk of damaging the package 140 or the lens it contains during handling. The rectangular shape also allows for efficient use of space, particularly when multiple packages are stored or transported together, as they can easily be arranged in a compact configuration.

However, in some embodiments, the package 140 may take on other shapes, depending on specific design requirements, manufacturing preferences, or aesthetic considerations. For example, the package 140 may be designed in a circular form. A circular package may offer a streamlined and visually distinct option that reflects the natural shape of the contact lens it contains. In addition to being aesthetically pleasing, a circular package may provide an even distribution of structural integrity, with no sharp edges or corners that may be prone to damage during transport. The smooth, rounded edges of a circular design may also make the package 140 easier to handle, especially in situations where precision is required, such as in sterile environments. Alternatively, the package 140 may adopt an oval or elliptical shape, which may offer both aesthetic appeal and functional benefits. In some specialized embodiments, the package 140 may take on a more geometric or abstract shape, depending on the specific branding or market needs of the manufacturer.

Regardless of the specific shape chosen, the overall design of the package 140 may maintain the functionality required to support and protect the receiving substrate 105A and the contact lens printed on it. In all embodiments, the package 140 may still feature the components, such as top edges 145-146 for sealing the package, a substrate holding body 147 for securely positioning the substrate, and internal cavities for cushioning or stabilizing the contents during transport.

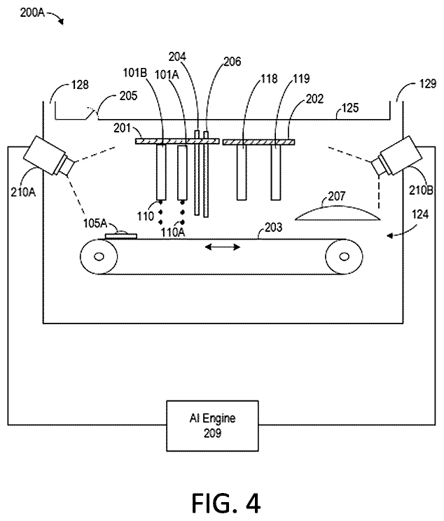

Referring now to FIG. 4, a schematic diagram illustrates some alternative aspects that may be incorporated into a 3D additive manufacturing station or system 200A for printing a contact lens on a substrate which may then be inserted into a package along with the printed lens. The system 200A includes several components such as the 3D printheads 101A-101B, actinic radiation sources 118 and 119, substrate 105A, an enclosure 125 with one or more ports 128 and 129, and a controlled atmosphere 124 ambient to the deposited polymerizable mixture 110.

Unlike traditional methods where the optical element 207 is removed from the substrate 105A by physical means, such as soaking in a solution or using release agents, this inventive embodiment of the process leaves the optical element 207 attached to the substrate 105A. The entire assembly, comprising the substrate 105A and the optical element 207, can then be inserted into a package 140, which serves as a sterile chamber for both the substrate 105A and the optical element 207. The package 140 may be sealed with a foil or another suitable material, which can be applied via heat sealing or other methods to maintain the integrity of the assembly during transport.

In some embodiments, the need for traditional release agents or soaking in solutions to separate the optical element 207 from the substrate 105A is eliminated. This approach reduces the number of steps required in the overall manufacturing process and minimizes potential damage to the optical element during handling. This may particularly be beneficial when dealing with delicate materials such as hydrogels, which can be sensitive to swelling or other physical forces that occur during conventional release methods.

Once the substrate 105A with the attached optical element 207 is inserted into the package 140, the next step involves either filling the package 140 with a sterilizing solution or preparing it for a final curing or sterilization process. A sterilizing solution, such as a buffered saline solution or another biocompatible fluid, may be added to maintain the hydration and sterility of the optical element 207. This solution helps keep the optical element 207 in a ready-to-use state, preventing dehydration or contamination prior to market distribution.

Additionally, the package 140 may undergo a final sterilization process after the substrate 105A and optical element 207 are inserted. This sterilization can be achieved through methods such as autoclaving, radiation sterilization, or exposure to other sterilizing agents, depending on the materials used for both the optical element and the package itself. The package 140 can be designed to withstand such sterilization processes, so that the integrity of the assembly (for example, as discussed in FIGS. 2A-2B above) remains intact throughout.

The substrate 105A with the optical element 207 may remain securely fastened within the package 140 throughout its lifecycle, including during transportation to medical professionals or directly to consumers. The ability to ship the optical element 207 attached to the substrate 105A offers several advantages, such as simplifying packaging and providing a stable base for the lens during shipping, reducing the risk of deformation or movement within the package 140.

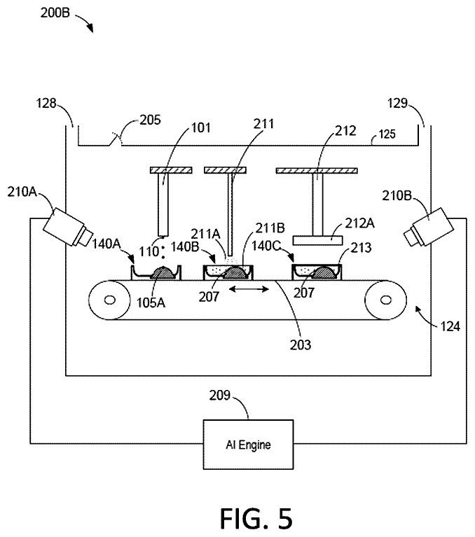

Referring now to FIG. 5, the schematic diagram illustrates an alternative embodiment of a 3D additive manufacturing station or system 200B designed for printing a contact lens 207 directly on a substrate 105A that is either pre-inserted into a package 140A (as in FIG. 2B) or is part of an integrated package unit such as 140B or 140C (as in FIGS. 3A-3B). The additive manufacturing system 200B shares many similarities with the system 200A depicted in FIG. 4, including its basic components and overall functionality. However, the primary distinction in this embodiment lies in the manufacturing process, which takes place entirely within the confines of the package 140A, 140B, or 140C. This process eliminates the need for subsequent handling or transferring of the contact lens 207, thus minimizing the risk of contamination or damage during the manufacturing process.

The system 200B may incorporate one or more printheads 101, positioned above the substrate 105A, which deposit droplets of polymerizable mixture 110 or 110A onto the substrate surface. In this embodiment, the substrate 105A is already seated within the package (140A-140C) at the start of the manufacturing process, or the substrate 105A and package (140A-140C) may be an inseparable unit, as illustrated by the integrated packages 140B and 140C. The substrate 105A and the packages (140A-140C) may be made of the same or different materials, depending on the specific requirements of the lens or the packaging material. For example, the substrate 105A may be made of a material conducive to the adhesion of the polymerizable mixture 110, while the package (140A-140C) may be made of a biocompatible or sterilizable plastic that provides a stable environment for transport and storage.

The system 200B, as part of an industrial assembly line, may operate on a conveyor belt or actuator 203 that moves the packages 140A, 140B, or 140C sequentially through various stages of the additive manufacturing process. The conveyor belt 203 allows for continuous production, facilitating high throughput, especially in industrial settings where thousands of lenses may need to be produced daily. As the package 140A-140C progresses along the conveyor belt 203, it passes under one or more printheads 101, each responsible for depositing a specific volume of polymerizable mixture 110 in a predefined pattern to form the desired optical element 207.

In some embodiments, the package 140A-140C and the substrate 105A within it are designed to accommodate the entire printing process. The package (140A-140C) itself serves as the support chamber throughout the printing and subsequent curing processes. This innovative approach offers several advantages, including the fact that the optical element 207 never needs to be removed from the substrate 105A. Instead, once the contact lens 207 is printed, the substrate 105A and package 140A-140C can be sealed, sterilized, and shipped directly to consumers or medical professionals.

The integrated package design, as exemplified by units 140A-140C, simplifies the overall manufacturing process by reducing the number of components required and streamlining packaging. For example, as in the case of 140B, the package 140B and substrate 105A are a single inseparable unit, meaning that the substrate 105A itself is an inherent part of the package 140B. This integrated approach eliminates the need to transfer the contact lens 207 from one component to another, further minimizing the risk of contamination. The use of different materials for the substrate 105A and package (140A-140C) can enhance the functionality of the overall system. For example, the substrate 105A can be made from a material with specific properties designed to facilitate the deposition and curing of the polymerizable mixture, while the package (140A-140C) can be made from a material optimized for transportation, storage, and sterilization.

The substrate 105A, which may be part of or inserted into the package 140A-140C, is carefully designed to hold the contact lens 207 securely in place during the printing process. The substrate 105A may include specific features such as recesses or locking mechanisms that align the package (e.g., 140A) and lens during printing. This prevents any unwanted movement of the substrate 105A during the process, so that each droplet of the polymerizable mixture is precisely placed to form the correct shape and curvature of the lens 207.

Once the printing process is complete, the contact lens 207 remains adhered to the substrate 105A, which itself remains securely fastened within the package 140A-140C. In this embodiment, the substrate 105A and the package (140A-140C) do not need to be separated at any stage of the process. Instead, the entire assembly is prepared for transportation by sealing the package (140A-140C) with a foil or other barrier material. The sealed package (140A-140C) maintains the sterility of the contact lens 207 and can be transported to the consumer or medical facility without requiring any additional handling of the optical element 207.

Referring again to FIG. 5, although some components, such as the actinic radiation sources 118 and 119, the oxygen sensor 204, and the UV blocking screen 206, are not explicitly depicted in the additive manufacturing system 200B, it is understood that these or equivalent elements may be incorporated into the system 200B, as they may be required for the precise curing and protection of the contact lens during the manufacturing process. These elements, as previously detailed in FIG. 4, may function similarly in system 200B, providing control over oxygen levels and light exposure during polymerization, thus enhancing the quality of the final lens product. In the embodiment illustrated in FIG. 5, the focus is on the later stages of the manufacturing process, where the lens 207 is handled within the package 140A-140C.

Once the contact lens 207 has been printed on the substrate 105A, which may already be integrated into or seated within the package 140A, 140B, or 140C, the entire package is moved along the conveyor belt 203 toward a sterilization section 211. The conveyor belt 203 facilitates the smooth transition of the package 140A-140C through various stages of the manufacturing process, making the entire system 200B suitable for high-volume production environments, such as industrial assembly lines. The conveyor belt system allows for precise synchronization with the various operations that occur at different stages of the production process.

At the sterilization section 211, a sterilization or saline solution 211A is introduced into the package 140A-140C to preserve the contact lens 207 in a sterile environment. The choice of solution 211A can vary depending on the specific requirements of the lens 207. For example, physiological saline is a commonly used solution for storing contact lenses, as it maintains the lens's hydration and prevents contamination during transport and storage. In some embodiments, the solution 211A may contain preservatives or antibacterial agents to further protect the lens 207 from microbial growth. Other potential solutions include isotonic or buffered saline, which help maintain the biocompatibility of the lens 207 when it comes into contact with the eye. The sterilization section 211 may involve a highly controlled environment where the solution 211A is dispensed into the package 140A-140C in precise quantities to avoid overfilling or underfilling, which may compromise the integrity or usability of the lens.

In some embodiments, the system 200B may include automated dispensing nozzles that carefully measure the volume of solution 211A to be inserted into the package 140A-140C. Sensors may be employed within the sterilization section 211 to monitor the exact amount of solution 211A introduced, and the Controller 209 may oversee this process, facilitating that the right concentration and volume of solution 211A are administered. This process guarantees that the lens 207 remains in an optimal state for storage and transportation. The package 140A-140C with the filled solution 211B is then moved forward by the conveyor belt 203 toward the next stage, which is the package sealing section 212.

At the sealing section 212, a foil 213 may be sealed onto the top of the package 140A-140C to create a hermetically sealed unit that will protect the contact lens 207 during storage and transportation. The sealing process may typically be accomplished by a heating rod or panel 212A, which applies heat to the edges of the package 140A-140C, bonding the foil 213 to the package 140A-140C. The foil 213 may be made from a material that is impermeable to moisture and air, facilitating that the saline solution 211B inside the package 140A-140C remains uncontaminated. Common materials for such foil seals 213 may include aluminum, plastic laminates, or a combination of both, providing a strong and durable barrier.

The heating panel 212A may be a precision tool that is temperature controlled to apply the exact amount of heat necessary to bond the foil 213 to the package 140A-140C without damaging the lens 207 or the package 140A-140C itself. The sealing process may also be monitored by sensors that detect the completion of the seal, so that no gaps or weak points are left in the foil. In some embodiments, the sealing section 212 may also include a mechanism for vacuum sealing, where the air inside the package 140A-140C is removed before the foil 213 is applied. This process further extends the shelf life of the lens 207 by preventing oxidation or contamination during storage.

As part of an industrial manufacturing setup, multiple packages 140A-140C can be processed simultaneously in parallel or sequentially, depending on the speed and capacity of the system 200B. The conveyor belt 203 facilitates that each package 140A-140C moves through the system 200B in a controlled and efficient manner, allowing for high throughput in large-scale production environments. The Controller 209 may be integrated into the sealing process as well, facilitating that each step is executed with precision, monitoring factors such as heat, pressure, and time during the sealing process.

In some embodiments, additional post-sealing processes may be integrated into the system 200B. For example, after the package 140A-140C is sealed, it may pass through a quality control section where cameras or sensors check the integrity of the seal 213 and the overall quality of the packaging. If any defects are detected, the Controller 209 may trigger an alert, and the package 140A-140C may be redirected for re-sealing or additional checks.

The use of an integrated package 140B or 140C, where the substrate 105A is part of the package itself, simplifies the manufacturing process by eliminating the need for additional steps where the lens 207 is removed from the substrate 105A and placed into a separate package. This not only speeds up the production process but also reduces the risk of contamination or damage to the lens. In some cases, the package 140A-140C may be designed to include additional features, such as a peelable foil seal or an easy-open mechanism, making it more user-friendly for the consumer. The printheads 101, the sterilization section 211, and the package sealing section 212 may be associated with their respective actuators (shown in FIG. 5) for provided horizontal and vertical movements.

In some variations of this embodiment, the package may contain more than one compartment, each designed to securely hold multiple substrates, allowing for the production of multiple lenses within a single package. The additive manufacturing station can also be configured to print across multiple substrates at one time within the width of the printhead, or feature multiple printheads that dispense different polymerizable mixtures to create lenses with varying properties or functions. Depending on the design, the substrate may be either fixedly or removably attached to the package using mechanisms such as flap-in or snap-in systems.

In a larger industrial setup, the method may involve the use of a package array, where multiple packages are positioned for simultaneous lens production. The array consists of individual packages, each containing a substrate for lens formation, and after the manufacturing process, the package array is sealed with a single foil. The packages are then separated by cutting along pre-scored lines or perforations to create individual sealed units ready for market distribution. This method can also accommodate various types of lenses, such as multifocal lenses or lenses for imaging devices, produced simultaneously on convex-shaped or concave substrates.

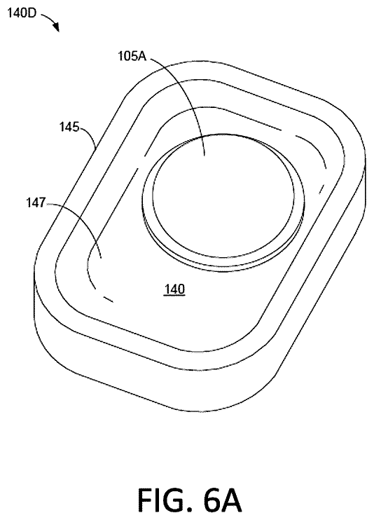

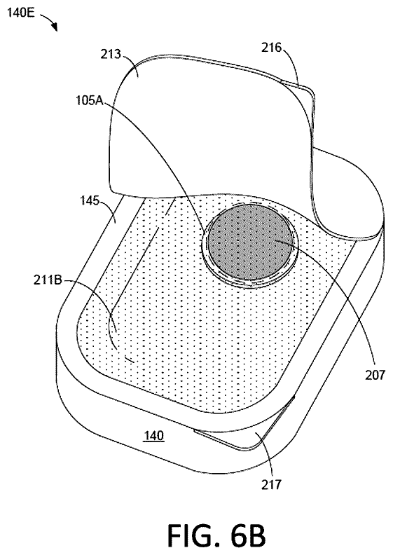

Referring now to FIG. 6B, an exemplary integrated package 140E (for example 140D as shown in FIG. 6A) is illustrated, which showcases a substrate 105A inside the package 140, along with methods for sealing the package 140 according to certain embodiments of the present invention. This figure highlights the design and process by which the contact lens 207, printed on the substrate 105A, is safely housed within the package 140 after undergoing additive manufacturing, sterilization, and packaging.

Once the contact lens 207 is printed directly onto the substrate 105A, as previously described, the integrated package 140E is then filled with a sterilization or saline solution 211B. The solution 211B serves multiple purposes: it maintains the hydration of the contact lens 207, preserves its flexibility, and prevents contamination or damage to the lens during storage and transport. The solution 211B may typically be an isotonic saline solution, providing biocompatibility with the user's eye. In some embodiments, the solution 211B may also include buffering agents to maintain pH balance or other specialized components to extend the shelf life of the lens 207.

After filling the package 140 with the sterilization solution 211B, the package 140 is moved to a sealing section 212 (FIG. 5), where a foil 213 is sealed over the top edges 145 of the package 140. The sealing process facilitates that the lens 207 and the solution 211B are securely contained within the package 140, preserving the sterility and preventing the solution 211B from evaporating or leaking. The foil 213 may be composed of materials such as aluminum or a multi-layered polymer, which offer a barrier against moisture, oxygen, and external contaminants. The heat-sealing process provides a strong bond between the foil 213 and the package 140, creating a hermetic seal that prevents any ingress of contaminants.

The heat-sealing of the foil 213 may be performed using a heating rod (e.g., 212A) or sealing mechanism, which applies pressure and heat along the edges 145 of the package 140. The edges 145 may be slightly raised or designed with grooves to help guide the heating rod, creating an even seal around the perimeter of the package 140. The heat-sealing process may be controlled by temperature and time settings, depending on the specific materials used for the foil 213 and the package 140. In some embodiments, the heat seal may also be reinforced with adhesive layers or secondary sealing processes to further enhance the durability of the package 140.

The seal 213 may be designed to be peelable, allowing easy access to the lens 207 inside the package 140. In this embodiment, the foil 213 may include a pull-tab 216, which is a small extension of the foil material designed for user interaction. The pull-tab 216 allows the user or medical practitioner to grip and peel back the foil 213 without the need for additional tools. This design provides convenience, especially in medical or clinical settings where the practitioner needs to access the lens 207 quickly and efficiently.

The pull-tab 216 is carefully positioned along the edge of the package 140 so that it can be easily grasped without compromising the integrity of the seal 213 during handling. In some cases, the pull-tab 216 may include tactile features, such as ridges or an embossed surface, to enhance the user's grip. Additionally, the pull-tab 216 may be color-coded or labeled with instructions to assist users in identifying how to open the package 140 correctly.

In some embodiments, the package 140 may also include a pull-tab support 217, which provides additional structural support to the pull-tab 216. The pull-tab support 217 may be a small elevated or extended section of the package 140 that facilitates that the pull-tab 216 remains accessible and is not flattened against the package 140 during transportation or storage. This feature may be especially useful when the packages are stacked or compressed, as it prevents the pull-tab 216 from becoming difficult to grasp. The pull-tab support 217 may also serve as a guide, directing the user to the correct location to pull back the foil 213.

The pull-tab support 217 can be designed as an integral part of the package 140, molded directly into the structure, or it can be a separate component that is attached during the packaging process. The pull-tab support 217 may be made from the same material as the package 140 or a more rigid material that provides additional strength. In some embodiments, the pull-tab support 217 may include a slight overhang or recess that helps to lift the pull-tab 216 slightly away from the surface of the package 140, making it easier to access.

Once the pull-tab 216 is pulled, the foil 213 peels away from the package 140, revealing the lens 207 and the solution 211B inside. The design of the package 140 and the foil 213 facilitates that the lens 207 remains submerged in the solution 211B until the package 140 is fully opened, preventing the lens 207 from drying out. In some cases, the foil 213 may also feature tamper-evident designs, such as perforations or seals that change color when the package 140 is opened. This may facilitate a user or medical professional verifying that the package 140 has not been opened or compromised before use. Tamper-evident seals provide an additional layer of security, particularly in medical environments where sterility and safety are of paramount importance.

In addition to the pull-tab 216 and pull-tab support 217, the package 140 may include other user-friendly features to enhance accessibility. For example, the package 140 may include a small indentation or cut-out section on the side of the package 140, allowing users to insert a fingernail or tool to begin peeling the foil 213. Such features make the packaging more intuitive and easier to open, reducing the risk of accidental damage to the lens 207 or spillage of the solution 211B.

The design of the integrated package 140E also allows for efficient mass production and automated handling. During the manufacturing process, multiple packages 140E may be produced and sealed simultaneously, with the foil 213 applied in a continuous roll. The pull-tab 216 and pull-tab support 217 are designed to withstand the mechanical stresses of automated packaging equipment, facilitating that each package is sealed securely without damaging the pull-tab or the lens inside.

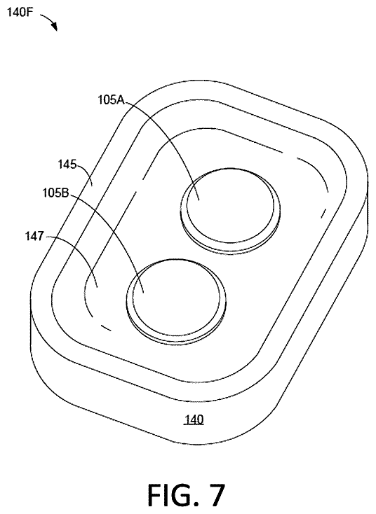

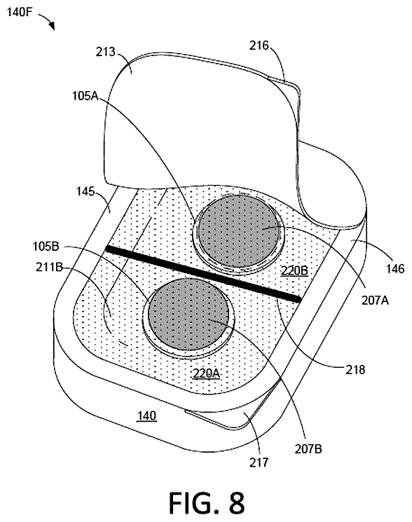

Referring now to FIG. 7, an exemplary integrated package 140F is depicted, comprising two substrates 105A and 105B. The two substrates, 105A and 105B, are designed to print and hold two contact lenses 207A and 207B (as shown in FIG. 8), which will be produced during the additive manufacturing process (as discussed in FIG. 5 above).

The idea behind having two substrates within a single package is to address the fact that contact lenses are typically sold in pairs. Manufacturing a pair of contact lenses in one integrated package 140 is beneficial as it allows for streamlined production, packaging, and distribution, making it easier for both manufacturers and users. The package 140 holds both lenses, reducing the need for two separate packages, thus optimizing space, material usage, and production costs. In addition, from the user's perspective, purchasing and handling a single package that contains both lenses is more convenient, facilitating that the lenses are stored in the same environment and undergo identical processes during production, storage, and sterilization.

In some embodiments, the package 140 may contain more than two substrates, such as three or four, or even more, depending on the need. The package may also include separate compartments 220A and 220B for the two substrates as shown in FIG. 8. These compartments are designed to securely hold the respective substrates 105A-105B and their printed contact lenses 207A-207B, in place during and after the manufacturing process. The separation of the compartments 220A-220B facilitates that each contact lens 207A-207B is kept in its own enclosed space, maintaining its integrity, cleanliness, and sterility.

A divider 218, which separates the compartments 220A and 220B, acts as a structural barrier between the two substrates 105A-105B, preventing any potential interaction between the contact lenses 207A-207B during storage or transportation. The divider 218 not only helps in organizing the substrates 105A-105B within the package 140 but also contributes to the structural integrity of the overall packaging system. The use of a divider 218 facilitates that, even if the package 140 is moved or subjected to external forces, the lenses 207A-207B and their substrates 105A-105B remain securely in place, minimizing the risk of damage.

In some embodiments, the divider 218 may be designed to have varying thicknesses or may even comprise a flexible material, allowing it to adapt to different shapes and sizes of substrates 105A-105B. For example, if substrates 105A-105B with different dimensions or curvature profiles are used, the divider 218 may be adjustable to accommodate such variations. The compartments 220A and 220B may thus be customized to suit different lens designs or prescriptions, allowing for greater versatility in packaging design. The divider may also be removable allowing the user or manufacturer to convert the package 140 from a multi-compartment design to a single large compartment if needed. This flexibility in design allows the package 140 to be repurposed for various use cases, such as holding a larger optical device or multiple small lenses.

Further, the two-compartment system may particularly be beneficial for contact lenses that are sold in pairs, as it allows for efficient and economical packaging. The package can be designed to hold lenses for different eyes (e.g., one for the left and one for the right), so that both lenses are produced, packaged, and stored together. This reduces the likelihood of errors in lens pairing and makes it easier for consumers to manage their lenses.

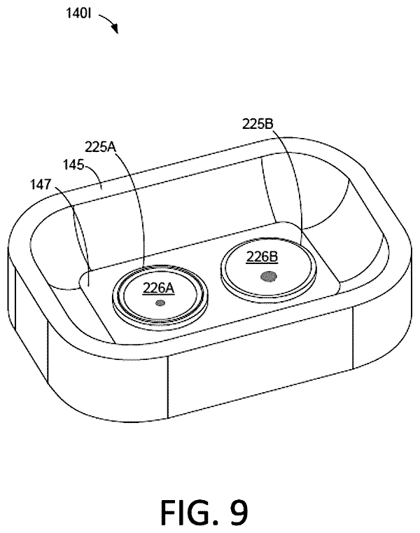

Referring now to FIG. 9, the package may alternatively be designed to accommodate two concave-shaped substrates 225A and 225B rather than convex substrates. The concave nature of the substrates allows for a different manufacturing approach, potentially reducing material usage and offering a more efficient method for producing lenses with specific curvature requirements.

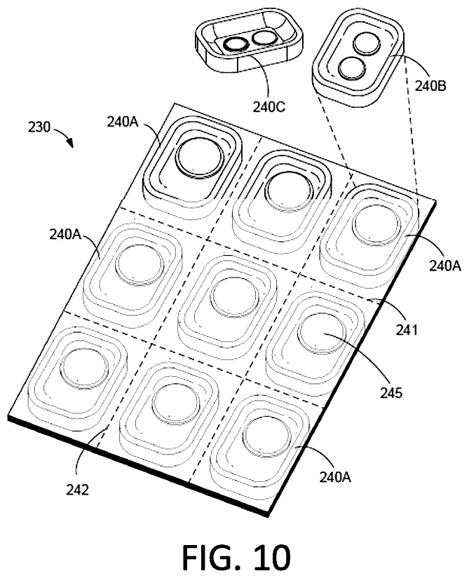

FIG. 10 illustrates an exemplary package array 230, which comprises a plurality of packages 240A organized in a grid-like structure. This configuration allows for efficient production in large-scale industrial manufacturing processes. Each package 240A contains substrates 245 on which contact lenses or optical elements are printed, facilitating streamlined operations during the additive manufacturing process. The array 230 is designed to hold multiple packages 240A together, enabling the simultaneous printing of lenses across numerous substrates in one integrated process.

The versatility of the package array 230 makes it ideal for use in various industries beyond just contact lens manufacturing. The array can be adapted for use in the production of other optical devices, medical equipment, or even electronic components that require precision manufacturing on a substrate. The use of an array system like 230 simplifies the process of handling multiple units, providing an efficient solution for industries that require high-volume production with consistent quality control.

In some embodiments, after the contact lenses are printed on the substrates 245 within each package 240A of the package array 230, the entire array 230 is moved to a sterilization section, similar to the sterilization section 211 shown in FIG. 5. At the sterilization section, each individual package 240A within the array 230 is filled with a sterilizing or saline solution, such as the solution 211B, which may serve to hydrate and sterilize the printed lenses within their respective substrates 245.

Once the filling process is complete, the package array 230 is transported to a package sealing section, such as the section 212 depicted in FIG. 5. Here, a sealing foil, similar to the foil 213, is applied to the top of each package 240A in the array 230. In some embodiments, a single foil may be applied to the entire array 230. The foil is heat-sealed to the edges of each package 240A, thereby creating a secure and sterile environment for the contact lenses housed inside. The heat-sealing process involves a heating rod (like 212A in FIG. 5) that carefully adheres the foil to the package's edges, such as edges 145-146, facilitating the integrity of the seal and preventing any leakage of the solution 211B. The sealed foil may be peelable and can include pull-tabs for easy removal by the end user or a medical practitioner.

Once the sealing process is completed, the entire package array 230, now filled with solution and sealed, is cut along the pre-scored lines or perforations 241-242. This cutting process allows for the separation of individual sealed packages 240A from the array. The perforations 241-242 are designed to facilitate easy separation without damaging the contents of each package 240A or compromising the sterile seal of the foil. Each separated package 240A now contains a fully printed contact lens or optical element within a sealed, sterile environment, making it ready for further distribution or direct shipment to the market.

In some embodiments, the entire process, from printing, filling, sealing, to separating, can be automated as part of an industrial manufacturing line.

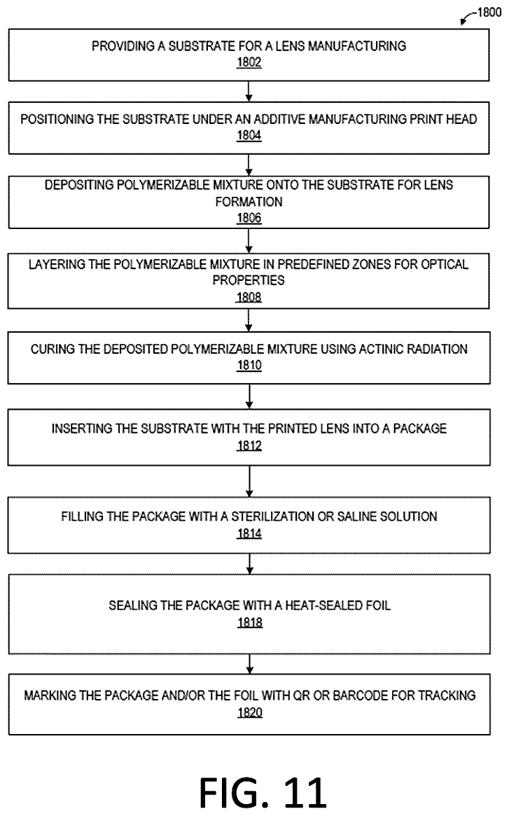

Referring now to FIG. 11, the flowchart 1800 illustrates the sequence of steps involved in the manufacturing process for creating a contact lens using additive manufacturing techniques on a substrate, followed by several stages of processing. The detailed steps outline the industrial process in which a contact lens is printed, cured, and prepared for packaging. Each step is carefully controlled to create a high-quality lens that meets the desired specifications.

At step 1812, the process continues with inserting the substrate with the printed lens into a package. Once the contact lens has been printed and cured on the substrate, such as substrate 105A from earlier figures, the substrate and the attached lens are placed into a specialized package, such as the packages discussed previously. This step eliminates the need to remove the lens from the substrate, thus reducing the risk of damage or contamination. The package may be designed to hold one or more substrates and may come in various configurations, such as convex-shaped or concave-shaped substrates, as previously described. The design of the package facilitates that the lens remains securely in place, and the substrate provides ongoing support during transport and storage.

At step 1814, the next phase involves filling the package with a sterilization or saline solution. This solution, often saline-based or a sterilizing agent, facilitates that the lens remains hydrated and sterile until it is ready for use. For instance, the sterilization solution can be a buffered saline solution commonly used to maintain the hydration of contact lenses. The package, with the lens already inside, is moved to a filling station where the solution is injected, filling the internal cavity around the substrate and lens. In some cases, the solution may include additional ingredients, such as preservatives or conditioning agents, to prolong the shelf life of the lens. This step is important for maintaining the lens's quality and providing its safety for the wearer.

At step 1818, the process involves sealing the package with a heat-sealed foil. After the package is filled with the sterilization or saline solution, it is moved to a sealing station where a protective foil, such as foil 213 shown in previous figures, is placed over the top edges of the package. The sealing process uses heat to bond the foil to the package, creating an airtight and watertight seal that preserves the sterility of the lens and prevents the solution from leaking. The foil may also have peelable properties, allowing the user to easily access the lens when needed. The heat-sealing process is carefully controlled to avoid damaging the lens inside the package and to facilitate that the seal is secure and tamper-proof. This step is important for preparing the lens for transportation and long-term storage.

At step 1820, the final step in the flowchart involves marking the package and/or the foil with a QR or barcode for tracking. This step involves printing a unique identifier, such as a QR code or barcode, onto the sealed package or directly onto the foil. This tracking system allows the package to be monitored throughout the distribution process, from the manufacturing facility to the end-user. QR codes can store a significant amount of information, such as batch number, manufacturing date, expiration date, and tracking information, allowing manufacturers, suppliers, and healthcare providers to trace the product at any stage. The marking step facilitates the package's authenticity and can help in recalling products, verifying compliance, and providing quality control.

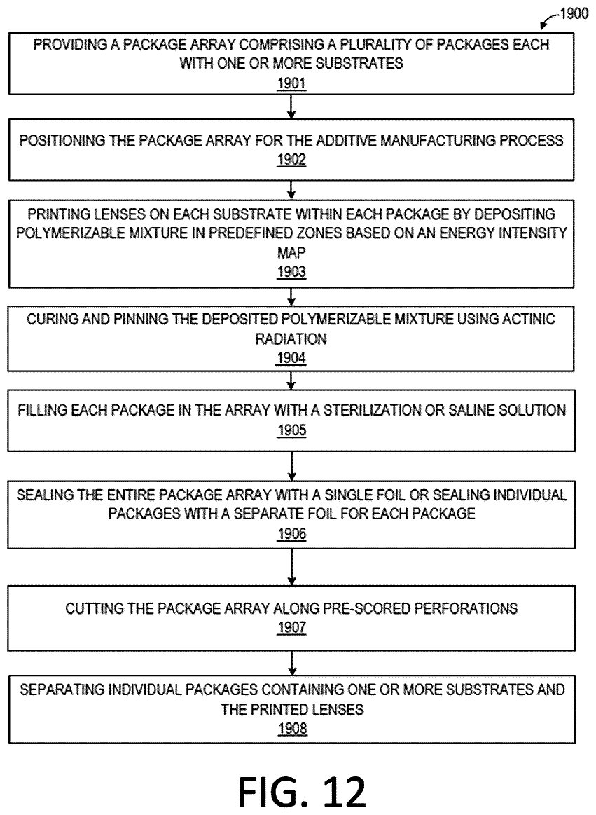

Referring now to FIG. 12, exemplary method steps are shown in a flowchart 1900 illustrating the detailed steps involved in manufacturing contact lenses using a package array system, where each package contains one or more substrates. The method leads to the simultaneous production, curing, filling, sealing, and separation of individual packages containing printed contact lenses. The following sections describe each step of the process in detail.

At Step 1901—Providing a Package Array Comprising a Plurality of Packages Each with One or More Substrates

In this step, a package array 230 is provided, which includes multiple packages 240A. Each package contains one or more substrates, such as convex-shaped (e.g., 105A) or concave-shaped (e.g., 225A, 225B) substrates, on which contact lenses will be printed. The substrates may be fixedly or removably attached to the packages within the array. The package array 230 can be part of an industrial setup where multiple packages are processed simultaneously. This setup allows the system to manufacture lenses on many substrates in a single workflow, improving efficiency. Each package in the array is configured to receive the lenses during the printing process, with the substrates positioned precisely to match the lens design. The number of substrates within a package may vary, depending on the design; for instance, some packages may include two or more substrates.

### At Step 1902—Positioning the Package Array for the Additive Manufacturing Process

The next step involves positioning the entire package array 230 under the additive manufacturing system, where lenses will be printed on the substrates inside each package 240A. The positioning of the package array is important because each substrate needs to align perfectly under the print heads 101A, 101B for accurate lens formation. The system uses precise positioning mechanisms, which may include conveyor belts, robotic arms, or other automated systems, to facilitate that the package array remains stable during the printing process. This positioning enables simultaneous printing of lenses on all substrates within the array. Once positioned, the package array is ready to undergo the lens printing process using polymerizable material deposition.

At step 1903—Printing Lenses on Each Substrate within Each Package by Depositing Polymerizable Mixture in Predefined Zones

In this step, the additive manufacturing print heads deposit polymerizable mixtures onto the substrates within each package. The deposition is guided to specific zones where the material must be deposited. This map dictates how much material is applied in different areas of the lens, providing the desired optical properties. For example, lenses with multifocal zones or specific refractive characteristics may require precise deposition in certain areas. The print heads move across the package array, depositing polymerizable material layer by layer on the substrates. The process is optimized for precision, with the Controller potentially adjusting the deposition based on real-time data from cameras monitoring the process. This facilitates that each lens in the package array meets its design requirements.

### At Step 1904—Curing and Pinning the Deposited Polymerizable Mixture Using Actinic Radiation

Once the polymerizable mixture is deposited onto the substrates, the next step is to cure and pin the material using actinic radiation. Actinic radiation sources, such as UV light, are used to initiate the polymerization of the deposited mixture, transforming the liquid or gel into a solid lens. Pinning refers to the initial stabilization of the material, which prevents the deposited layers from shifting or distorting before the final curing is completed. The curing process hardens the lenses, locking in their optical and structural properties. Each package in the array receives controlled exposure to actinic radiation, either from overhead sources or through an automated curing station. Depending on the polymerizable material used, the curing time and radiation intensity are adjusted to provide proper solidification of the lenses in all packages.

At step 1905—Filling Each Package in the Array with a Sterilization or Saline Solution

Once the lenses have been printed and cured on the substrates within the package array 230, each individual package 240A in the array is moved to a sterilization or solution filling section, such as the one described in FIG. 2B (211). Here, each package is filled with a sterilization or saline solution 211B. The purpose of this solution is to maintain the hydration and biocompatibility of the lenses, so that they are ready for immediate use upon removal from the package. The filling process can be automated, with each package being injected with a precise amount of solution to provide complete coverage of the lens inside. In some embodiments, a sterilization solution may be used so that the lens remains free of contaminants, while in others, a saline solution may be used to maintain lens hydration.

At Step 1906—Sealing the Entire Package Array with a Single Foil or Sealing Individual Packages with a Separate Foil for Each Package

After filling the packages with the sterilization or saline solution, the next step involves sealing the package array. There are two possible methods for sealing. In one embodiment, a single foil 213 may be used to cover and seal the entire package array at once. The foil is heat-sealed onto the edges of the package array, providing an airtight and sterile environment for the lenses inside. Alternatively, each individual package 240A in the array can be sealed with its own foil. This method involves sealing each package separately, which may be beneficial when the packages are designed to be separated after the manufacturing process. The sealing process may be automated, with heat-sealing rods applying the necessary pressure and heat to bond the foil to the edges of the packages, forming a secure and tamper-proof seal.

### At Step 1907—Cutting the Package Array Along Pre-Scored Perforations

Once the package array has been filled and sealed, it is moved to a cutting section, where the array is cut into individual packages. The package array 230 typically contains pre-scored perforations (e.g., 241-242) that indicate where the array should be cut to separate the individual packages. An automated cutting mechanism can follow these perforations, providing a clean and precise separation of the packages. This process allows for efficient separation of the packages while maintaining the integrity of the sealed environment within each package. The individual packages can now be handled independently, either for distribution or further processing, such as labeling or tracking

### At Step 1908—Separating Individual Packages Containing One or More Substrates and the Printed Lenses

The final step in the process involves the separation of individual packages from the package array. Each separated package now contains one or more substrates with the printed contact lenses inside, sealed with a foil and filled with sterilization or saline solution. These packages are now ready for distribution to retailers or customers. In some embodiments, the individual packages may include tracking codes, such as barcodes or QR codes, allowing them to be tracked throughout the distribution process. The separation of packages allows for flexibility in packaging and distribution, as the lenses can now be sold individually or in pairs, depending on the configuration of the substrates within the packages.

### “Dry” Packaging

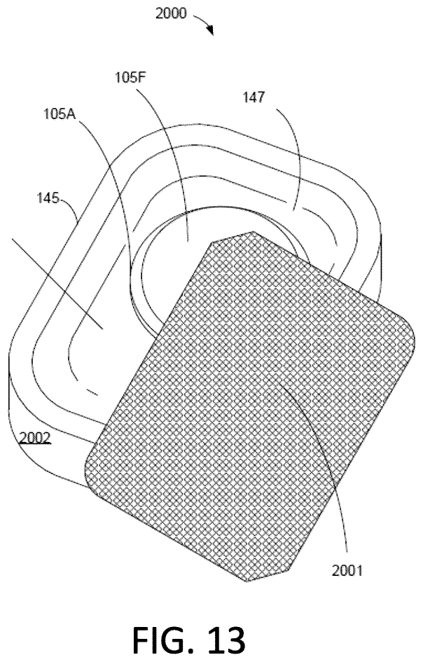

Alternate embodiments of the present invention may leverage many of the details described above, but package the lens and substrate combination in a “dry” or un-hydrated state rather than in the presence of saline or the like in a “wet” state. Referring now to FIG. 13, an integrated assembly 2000 suitable for dry packaging and/or dry shipping an un-hydrated optical device 105F is illustrated. The integrated assembly 2000 may include a dry shipment package base 2002 with a receiving substrate suitable for forming an un-hydrated optical device 105F upon. An un-hydrated optical device 105F may include, by way of non-limiting example, a contact lens, an intraocular lens, a prosthetic lens, a prosthetic insert, an aesthetic lens, or other article suitable for placement in an ophthalmic environment. A dry shipment package base 2002 may include a receiving substrate 105A as a single inseparable unit or as an insert as described in detail above. A package seal 2001 may be placed over the un-hydrated optical device 105F thereby containing the un-hydrated optical device 105F in a protected environment.

An integrated design that includes a receiving substrate 105A as a single inseparable unit may simplify manufacturing, packaging, and handling process by combining the receiving substrate 105A and the dry shipment package base 2002 into a single continuous unit 2002 including one or more materials.

The material for the integrated assembly 2000 may include, by way of non-limiting example, one or more of: a biocompatible polymer, such as polypropylene or polyethylene, which offers the strength, flexibility, and chemical resistance necessary for both the receiving substrate 105A and the dry shipment package 2002. These materials provide a seamless transition between the substrate 105A and the surrounding dry shipment package 2002, providing a uniform structure that can withstand the various stages of the contact lens manufacturing process, including deposition, curing and transport. In some embodiments, the integrated assembly 2000 may include a substrate 105A made of one material and the dry shipment package base 2002 made of another material different from the substrate 105A.

A substrate holding body 147 may be an integral part of the dry shipment package 2002, serving as the primary support structure for the receiving substrate 105A. The substrate holding body 147 is designed to maintain the substrate 105A in a stable and secure position within the dry shipment package 2002. This prevents movement during manufacturing processes, such as 3D printing or curing of the contact lens. Additionally, the substrate holding body 147 may be contoured to match the shape of the substrate 105A, further stabilizing it within the dry shipment package base 2002 and preventing any unwanted shifting or displacement.

Top edge 145 of the dry shipment package base 2002 may include a size and shape designed to facilitate sealing the dry shipment package base 2002 after the contact lens is manufactured on the receiving substrate 105A. Top edge 145 may include a flat or slightly raised portion to accommodate a foil or other sealing material, which can be heat-sealed to create an airtight and sterile environment within the dry shipment package 2002. The sealed package may protect the lens from contaminants such as dust, bacteria, and moisture, so that it remains in usable condition until it reaches the end user.

In some embodiments, the top edge 145 of the dry shipment package base 2002 may feature additional sealing mechanisms, such as a tamper-evident seal or a pull-tab for easy opening. Such a design may further enhance the usability and safety of the dry shipment package 2002, so that the lens remains disinfected until it is ready to be used. The tamper-evident seal may be made from a transparent material, allowing for visual inspection of the lens without opening the package.

Furthermore, the integrated nature of the dry shipment package base 2002 and the receiving substrate 105A simplifies the manufacturing process by eliminating the need for separate components. This reduces the complexity of production, lowers manufacturing costs, and improves overall product consistency. By using a single material and construction process, manufacturers can streamline their operations, resulting in higher efficiency and fewer errors.

The receiving substrate 105A may include surface properties to enhance the wetting of the polymerizable material deposited via additive manufacturing printing. For example, the surface of the receiving substrate 105A may be treated with a coating or microtextured to increase the surface area and improve the bonding of the lens material to the substrate 105A. Such treatments may enhance an overall quality of a formed optical device as deposited polymerizable mixture adheres properly to the receiving substrate 105A during the printing and curing processes and may allow for improved edge feature formation control.

The dry shipment package base 2002 may also include additional features to facilitate handling during transport. For example, the exterior of the dry shipment package base 2002 may be textured or include gripping surfaces to make it easier for workers to handle, especially in sterile environments where gloves are used. Additionally, the dry shipment package base 2002 may be designed with stacking features, allowing multiple packages to be easily stored and transported without risk of damage.

The dry shipment package base 2002 as illustrated in FIG. 13 is designed with a rectangular shape, featuring smooth or curved corners along its top edge 145. The rectangular form offers practicality in terms of handling, stacking, and storage, making it suitable for various stages of the contact lens manufacturing and transport processes. The rounded or curved corners enhance ergonomics, reducing the risk of damaging the dry shipment package base 2002 or the lens it contains during handling. The rectangular shape also allows for efficient use of space, particularly when multiple packages are stored or transported together, as they can easily be arranged in a compact configuration.

However, in some embodiments, the dry shipment package base 2002 may take on other shapes, depending on specific design requirements, manufacturing preferences, or aesthetic considerations. For example, the dry shipment package base 2002 may be designed in a circular form. A circular package may offer a streamlined and visually distinct option that reflects the natural shape of the contact lens it contains. In addition to being aesthetically pleasing, a circular package may provide an even distribution of structural integrity, with no sharp edges or corners that may be prone to damage during transport. The smooth, rounded edges of a circular design may also make the dry shipment package base 2002 easier to handle, especially in situations where precision is required.

Regardless of the specific shape chosen, the overall design of the dry shipment package base 2002 may maintain the functionality required to support and protect the receiving substrate 105A and the contact lens printed on it. In all embodiments, the dry shipment package base 2002 may still feature the components, such as one or more top edges 145 for sealing the package, a substrate holding body 147 for securely positioning a receiving substrate 105F, and internal reservoir area for receiving hydration fluid that can be added later at the customer location.

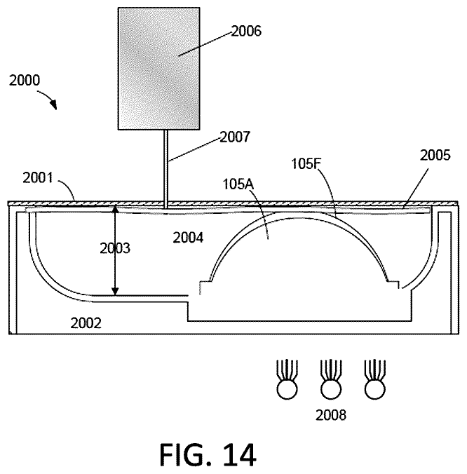

According to the present invention, an optical lens 105F may be formed on a receiving substrate 105A and packaged dry with a seal 2001 along a top edge 145 of the dry shipment package base 2002. In some embodiments, the seal 2001 may preferably be a foil or other heat-resistant material. Referring now to FIG. 14, the integrated assembly 2000 including the combined dry shipment package base 2002 and seal 2005 and optical lens 105F, may be shipped without the optical lens 105F being released from the substrate 105A. Shipping a dry lens eliminates the shipping of fluid which is relatively heavy (as compared to a dry package) and includes other variables.

At a point of use, a hydration fluid 2004 may be inserted into the integrated assembly 2000. Insertion may be accomplished via a piercing nozzle 2007 in fluid communication with a source of hydration fluid 2006. The hydration fluid 2004 is received into a reservoir 2003 for containing the hydration fluid 2004. The hydration fluid 2004 may act to hydrate the dry lens 105F and release the lens 105F from the substrate 105A. Preferably the hydration fluid 2004 has a surface that submerges the optical lens 105F.

In some embodiments, the hydration fluid 2004 may also include chemical sterilizing agents to sterilize the optical lens 105F prior to being worn.

Some embodiments may include a sterilization mechanism 2008, such as a heat source for heat sterilization, or a source of an appropriate energy wavelength (e.g., ultraviolet) to sterilize the optical lens 105F.

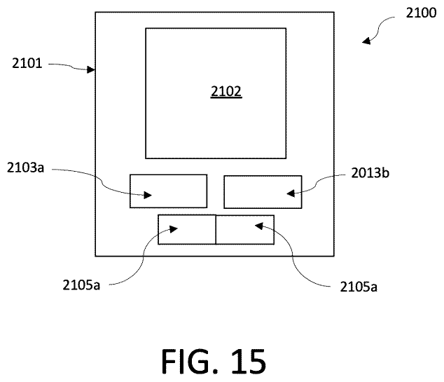

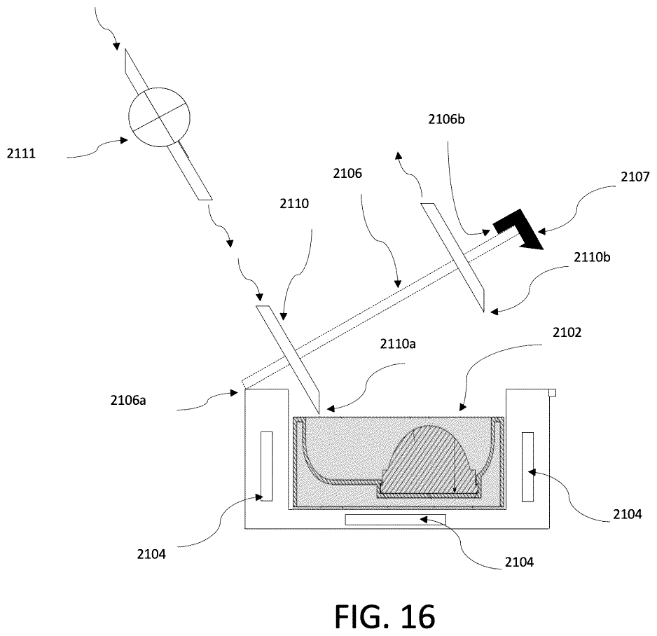

One exemplary embodiment of a device that can be used for removal and hydration of the lens at point of use is illustrated in FIGS. 15-16. FIG. 15 is a schematic view of a hydration device 2100 that can be used at a third-party location such as a user's residence or at a doctor's office. As a high-level concept, the hydration device is capable of receiving within a package nest 2102 the sealed package including the ophthalmic substrate and attached ophthalmic lens, piercing the package and injecting through the opening a hydration fluid to thereby hydrate the lens within the package and cause it to separate from the substrate. The hydration fluid may also include a disinfectant to ensure the lens is suitably clean before use by a patient. The hydration fluid may be any well-known contact lens solution currently used with contact lenses, such as multi-purpose saline solutions.

Referring to FIG. 15, the hydration device includes an external housing 2101, a package nest 2102 that receives the package, one or more fluid reservoirs 2103a, 2103b, one or more heating elements 2104 (see FIG. 16), and control units 2105 for controlling operation of the device. The package nest in connection with the package received therein is shown in more detail in FIG. 16. The package nest 2102 has a recess sized and shaped to receive therein a package such as those described herein. A package nest lid 2106, preferably hinged at one side 2106a thereof and having a latch 2107 at a second end 2106b thereof, operates to seal the package nest once the package is positioned therein. In one embodiment, the package lid includes at least one preferably tubular fluid conduit 2110. The fluid conduit has a length and a first end 2110a shaped such that it will pierce the sealed foil of the package when the package lid is properly closed. This fluid conduit is in line with a suitable fluid pump 2111 and a first fluid reservoir 2103a that contains the hydration fluid.

In order to hydrate and remove the lens from the substrate to which it is attached, in one preferred embodiment, the lens can remain in the presence of the hydration fluid for approximately 20 minutes at a fluid temperature of approximately 80 degrees Fahrenheit. To heat the hydration fluid, the hydration device further includes one or more heating elements 2104. In the illustrated embodiment, one or more heating elements 2104 positioned around the package nest. Those skilled in the art will readily understand alternative heating means, such as heating the fluid in the reservoir before or while it is injected.

The illustrated embodiment also includes a second fluid conduit 2110b similar to the first, but for removing used fluid from the package following hydration and disinfection. In an alternate embodiment, the second fluid conduit is not necessary, and following hydration the customer removes the package, peels back the foil and empties the hydration fluid in the same manner as saline is commonly emptied from the package by the user today with wet packaged lenses.

At the customer site two things must happen to ensure the lenses are suitable for wearing by a customer. As noted previously, the lenses must be removed from the substrate and suitably disinfected for use. A hydration device suitable for these tasks may take various forms so long as it is capable of surrounding the lens/substrate combination with hydration fluid and heating that hydration fluid to the required temperature and for the required period of time. In its simplest form, the hydration device may resemble well known prior art heating devices used to disinfect hard contact lenses. The heating device would be sized and shaped to receive therein the package including the substrate and attached lens. The foil can be removed or pierced and hydration fluid inserted, the device closed and the fluid heated for the appropriate time and temperature.

It is to be noted that lenses produced and delivered as described herein do not need to undergo expensive sterilization procedures as do current lenses produced using cast molding manufacturing. In cast molding processes, the lenses are hydrated and removed from the mold halves on the manufacturing line. As such they must be packaged with saline solution or the like to ensure they remain hydrated through shipping and delivery. For lenses packaged wet, they must be suitably sterilized within the package, as wet packaged lenses are prone to growth of microbes and the like if not suitably sterilized. Lenses packaged dry according to the present invention do not require such complicated and expensive sterilization processes on the manufacturing line.

### General Remarks

Although the present description and claims occasionally refer to a mixture (such as a polymerizable mixture), an initiator, or other additives, it is within the scope of this invention that the materials and compositions defined herein may comprise one, two, or more types of individual constituents. In such embodiments, a total amount of a respective constituent should correspond to an amount defined above for the individual constituent.

The(s) in the expressions: mixture(s), initiator(s), etc. indicates that one, two, or more types of the individual constituents may be present. On the other hand, when the expression one is used, only one (1) of the respective constituent is present.

It should be understood that the expression % means the percentage of the respective component by weight, unless otherwise noted.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, separation of various system components in the embodiments described above should not be understood as requiring such separation in all embodiments, and it should be understood that the described program components and systems can generally be integrated together in a single hardware and/or software product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method of producing an ophthalmic lens, the method comprising:
depositing polymerizable mixture onto a receiving surface of a substrate, the substrate positioned within a package;
layering the polymerizable mixture in one or more passes of an additive print head over the substrate, wherein successive layers of the polymerizable mixture are deposited to form a three-dimensional structure of the ophthalmic lens;
curing the polymerizable mixture deposited on the substrate by exposing it to an actinic radiation, thereby initiating polymerization and forming a solid form of the ophthalmic lens;
sealing the substrate and ophthalmic lens formed thereon within said package in a dry, non-hydrated state, wherein the formed ophthalmic lens remains adhered to the receiving surface; and
shipping the sealed package having the substrate and formed ophthalmic lens therein in the dry, non-hydrated state.

2. The method according to claim 1, additionally comprising the step of, at a site remote to a site of forming the ophthalmic lens, at least partially filling the package with a hydration fluid to thereby hydrate said ophthalmic lens and release it from the receiving surface.

3. The method according to claim 2, wherein filling step further comprises creating an opening in said sealed package, and injecting said hydration fluid into said package via said opening.

4. The method according to claim 1, wherein the substrate is integral with the package.

5. The method according to claim 1, wherein the substrate is removably secured to the package prior to forming the ophthalmic lens.

6. The method according to claim 1, wherein the sealing step further comprises heat-sealing a foil lid onto said package to create a moisture barrier.

7. An ophthalmic lens package assembly comprising:
a substrate having a convex upper surface;
a contact lens having a concave posterior surface and a convex anterior surface, wherein the concave anterior surface is adhered to the convex surface of the substrate, and wherein said contact lens is in a dry, non-hydrated state;
a package having an upper side and a size and shape defining a recess therein, said substrate and adhered contact lens positioned within said recess; and
a lid sealed to the upper size of the package, said lid providing a moisture barrier to maintain the contact lens in said dry, non-hydrated state during shipping and handling.

8. The ophthalmic lens package assembly according to claim 7, wherein said substrate is integral with said package.

9. The ophthalmic lens package assembly according to claim 8, wherein said package further comprises a substrate receiving portion, and the substrate is removably inserted into said substrate receiving portion.

10. The ophthalmic lens package assembly according to claim 9, wherein the package further comprises a flap-in mechanism and the substrate further comprises a base locking mechanism, wherein the flap-in mechanism securely engages the base locking mechanism to provide secure positioning of the substrate and adhered contact lens within the package.

11. The package according to claim 10, wherein the flap-in mechanism is a snap-in mechanism configured to securely snap the substrate into place within the substrate receiving portion.

12. The package of claim 9 further comprising one or more compartments within the package, each compartment designed to securely hold at least one substrate, wherein the at least one substrate is either fixedly or removably attached to the package within the substrate receiving portion.

13. The package according to claim 7, wherein the package and the substrate are made of same material.

14. The package according to claim 7, wherein the package and the substrate are made of different materials.

15. A method of providing an ophthalmic lens comprising:
forming said ophthalmic lens by
a) positioning a package having a substrate within a cavity of said package at an additive manufacturing station having an additive manufacturing printhead,
b) depositing droplets of a polymerizable mixture from said additive manufacturing printhead onto a receiving surface of the substrate,
c) allowing the droplets of polymerizable mixture deposited onto the receiving surface to be acted upon by natural forces,
d) integrating the droplets of polymerizable mixture deposited with gelled polymerizable mixture on the receiving surface to form a combined volume of polymerizable mixture,
e) pinning the combined volume of polymerizable mixture to form a three-dimensional structure directly on the substrate within the package, and
f) curing the combined volume of polymerizable mixture to form an un-hydrated ophthalmic lens attached to the substrate;
sealing said package with said substrate and formed lens therein with a moisture barrier to maintain said lens in a dry, un-hydrated state within said package; and
shipping said sealed package to a third party with said ophthalmic lens in said dry, un-hydrated state and adhered to said substrate.

16. The method according to claim 15 further comprising the step of instructing a user to insert hydration fluid into said package at said user location, wherein said hydration fluid hydrates said lens and releases said lens from said substrate.

17. The method according to claim 15, wherein the package includes one or more compartments designed to securely hold multiple substrates.

18. The method according to claim 15, wherein the substrate is fixedly attached to the package during the additive manufacturing process.

19. The method according to claim 15, wherein the substrate is removably attached to the package using a flap-in or snap-in mechanism.

20. The method according to claim 15, wherein the package is part of a package array, allowing for multiple lenses to be printed simultaneously and separated post-production.
